(19) United States
(12) Patent Application Publication
(10) Pub. No.: US 2018/0370825 A1
(43) Pub. Date: Dec. 27, 2018

(54) METHOD AND APPARATUS FOR CLARIFYING INDUSTRIAL WATER

(71) Applicant: KURITA WATER INDUSTRIES LTD., Tokyo (JP)

(72) Inventors: Yasuhiro OOI, Tokyo (JP); Keijirou TADA, Tokyo (JP); Akihiro FUJII, Tokyo (JP)

(21) Appl. No.: 16/064,860

(22) PCT Filed: Sep. 20, 2016
(86) PCT No.: PCT/JP2016/077637

§ 371 Date: Jun. 21, 2018

(30) Foreign Application Priority Data
Jan. 29, 2016 (JP) 2016-016044

(51) Int. Cl. C02F 1/56; B01D 21/01; B01D 61/04; B01D 61/16; B01D 61/58; C02F 1/44

(52) U.S. Cl. CPC C02F 1/56; B01D 21/01; B01D 61/04; C02F 2103/001; B01D 61/58; C02F 1/44; B01D 61/16

(57) ABSTRACT

Provided are a method and an apparatus for clarifying industrial water that enable industrial water to be clarified to a high degree with a small amount of coagulant instead of an inorganic coagulant, such as PAC, aluminum sulfate, or ferric chloride, which need to be used in a large amount for clarifying industrial water and are capable of producing treated water having qualities particularly suitable for an RO membrane treatment. The method for clarifying industrial water includes adding a melamine-formaldehyde resin acid colloidal solution to industrial water in order to coagulate the industrial water and subsequently filtering the coagulated water. The coagulated water may be directly filtered with a pressure or gravity filtration device, or with a microfiltration or ultrafiltration membrane module, without being subjected to solid-liquid separation using a sedimentation or floatation separation device prior to the filtration treatment.

### TECHNICAL FIELD

The present invention relates to a method and an apparatus for producing clarified water from industrial water by coagulation and filtration. The present invention relates to a method and an apparatus for clarifying industrial water that enable treated water having high clarity to be produced by adding a small amount of coagulant instead of an inorganic coagulant such as polyaluminum chloride (PAC) which is normally used in coagulation treatment of industrial water.

The term “industrial water” used herein refers to surface water, such as river water, lakes, dam lakes, and reservoirs, which is used as raw water and clarified by coagulation, filtration, or the like for producing industrial or city water and also to water fed to a company after being subjected to simple coagulation and filtration treatments in a water treatment plant. Note that, the industrial water does not include well water or spring water.

### BACKGROUND ART

<Treatment of Industrial Water>

The industrial water used in Japan is produced by performing a coagulation treatment using PAC and reducing the turbidity of the coagulated water to a certain degree lower than the turbidity standard by sedimentation, filtration, or the like in a water treatment plant and subsequently fed to a factory.

The industrial water received in the factory is coagulated using, in many cases, an inorganic coagulant, such as PAC, aluminum sulfate, or ferric chloride, and, commonly, PAC, regardless of whether or not a coagulation treatment has been performed in the water treatment plant. The coagulated water is filtered and used in the factory.

The industrial water coagulated using PAC is subjected to primary solid-liquid separation using a sedimentation separation device or a floatation separation device and subsequently clarified by filtration with a gravity or pressure filtration device. Hereby, treated water is produced.

In the case where the amount of PAC required by the coagulation treatment is 20 mg/L or less, the water is commonly passed directly through the gravity or pressure filtration device without being subjected to primary solid-liquid separation using a sedimentation separation device or a floatation separation device prior to the filtration treatment.

In the case where the industrial water has low turbidity, there has also been employed a method in which the coagulation treatment using PAC is omitted or the coagulation treatment is performed using a small amount of PAC and the coagulated water is passed directly through a microfiltration (MF) membrane module or an ultrafiltration (UF) membrane module to produce clarified water.

«Objectives for Treating Industrial Water»

The primary objective for the coagulation and filtration treatments of the industrial water is to reduce the turbidity of the industrial water.

The turbidity of the treated water which is certified as appropriate for treating industrial water by the manufacturer of industrial water facilities is 1 degree or less or 0.5 degrees or less as measured using a kaolin standard solution in accordance with JIS K0102. The turbidity of the actual treated water is 0.2 degrees or less and, in some cases, 0.1 degrees or less.

«Turbidity and netNTU»

The minimum absorbance measurable with a 50-mm cell at a wavelength of 660 nm in accordance with JIS K0102 is 0.001, which corresponds to 0.1 degrees since the coefficient of turbidity is approximately 100 times.

Assuming that the tolerance error in absorbance is 0.002 or less, the precision of analysis is ±0.2 degrees.

In measurement verification, a turbidity level of less than 1.0 degrees is represented as “1<” (less than 1).

Accordingly, in Test examples and Examples below, turbidity was measured to two decimal places with 2100Q produced by HACH in order to measure further low turbidity levels.

Specifically, netNTU was employed. The index netNTU is the measured turbidity level (NTU) minus the measured turbidity level of ultrapure water (blank value: normally, 0.04 to 0.07).

The device 2100Q produced by HACH has an accuracy of 0.01 because it detects turbidity on the basis of two turbidity levels measured using transmitted light and 90 scattered light having high detection sensitivity. The JIS K0102 turbidity level that corresponds to 1.0 NTU is not 1 degree but approximately 0.6 to 0.7 degrees.

«Requirement for netNTU (Turbidity) of RO Membrane Feedwater»

In the case where the treated water is fed to a reverse osmosis (RO) membrane to produce desalted water, the treated water is required to have clarity higher than the above levels, that is, for example, 0.05 or less netNTU.

It is not possible even for 2100Q produced by HACH to accurately detect such a low turbidity level.

Therefore, SDI has been employed worldwide for measuring the clarity (turbidity) of RO membrane feedwater.

The SDI used for measuring turbidity due to suspended microparticles is described below together with “indices of the likelihood of RO membrane feedwater fouling membranes” which is used for assessing the clarity of treated water in the present invention.

«Assessment of Clarity of Treated Water»

Treated water produced by the coagulation treatment of industrial water is required to have the highest clarity level in the case where the treated water is used as RO membrane feedwater. The second highest clarity is required in the case where the treated water is subjected to ion-exchange treatment in order to produce pure water.

The evaluations of the clarity of the treated water and the criteria used for assessing clarity are described below.

[SDI (Silt Density Index)]

SDI defined in ASTM D4189 is used for assessing the likelihood of RO membrane feedwater having unmeasurable trace turbidity fouling RO membranes.

SDI is the same evaluation method as FI (fouling index) defined in JIS K3802.

The specific method for measuring SDI is as follows.

A water sample is passed through an MF membrane having a maximum pore size of 0.45 μm and a diameter of 47 mm under a pressure of 0.2 MPa. The amount of time T₀ it takes for the first 500 mL of the water sample to permeate through the membrane is measured. After the water sample has been passed through the membrane for 15 minutes, the amount of time T₁₅ it takes to produce the next 500 mL of permeate is measured. The SDI (FI) is calculated from the time T₁₅ and the time T₀ using the following formula.

SDI(FI)=(T15−T₀)/T₁₅×100/15 (min)

(T₁₅-T₀)/T₁₅×100 represents a reduction (%) in the filtration rate which occurs while the water sample is passed through the membrane for 15 minutes. The SDI (FI), which is calculated by diving the above reduction by 15 minutes, represents a reduction (%) in filtration rate per minute.

If the water sample does not contain any foulant, the SDI (FI) of the water sample is 0.00, which is the best value. If the MF membrane becomes clogged and not capable of producing permeate after the water sample has been passed through the membrane for 15 minutes, the SDI (FI) of the water sample is 6.67, which is the worst value.

The recommended SDI of RO membrane feedwater varies with the manufacturer and brand of the RO membrane and is generally 3 to 4 or less.

[MFF (Micro Filter Fouling Factor)]

In the measurement of MFF, 1 L of a water sample is passed through an MF membrane having a maximum pore size of 0.45 μm in batches of 500 mL under a reduced pressure of −67 kPa. The MFF of the water sample is determined by calculating the ratio T₂/T₁ of the amount of time T₂ required for the second filtration to the amount of time T₁ required for the first filtration.

MFF is a method for measuring turbidity due to microparticles as in SDI.

FIGS. 1 and 2 illustrate the correlations between MFF and SDI in the test results obtained by the inventor of the present invention.

According to the test results, SDIs of 4.0, 3.0, and 2.0 corresponded to MFFs of 1.10, 1.06, and 1.025, respectively. The best MFF is 1.00.

[SFF (Soluble Polymer Fouling Factor)]

Industrial water contains biopolymers, which are soluble high-molecular substances metabolized by algae, in addition to suspended microparticles. Examples of the biopolymers include submicron gel microparticles unmeasurable with SS.

The biopolymers are composed primarily of polysaccharides and commonly remain in treated industrial water. When such water is passed through an RO membrane, the biopolymers may foul the membrane and reduce the permeation flux of the membrane.

Most of the biopolymers contained in industrial water are removed by coagulation using PAC. Since the concentration of the biopolymers in the coagulated water is 10 to 100 μg/L, which is a trace amount, the biopolymers do not cause significant problems when the treated water is used in general applications. However, in the case where the treated water is fed to an RO membrane, the biopolymers, which have a molecular weight of about 10 million, may concentrate and adhere to the surface of the RO membrane and foul the membrane even when the content of the biopolymers is trace.

In the case where the treated water is subjected to an ion-exchange treatment to produce pure water, biopolymers that are neutral polysaccharides having no charge fail to be removed by the treatment and remain in the ion-exchanged water.

SFF is a method for evaluating the impact of the biopolymers on the fouling of the RO membrane.

In SFF, the microviscosity of the biopolymers is assessed using the ratio T₁/T₀ of the amount of time T₁ it takes for a water sample to permeate through an MF membrane to the amount of time T₀ it takes for reference water (clarified water) to permeate through the MF membrane.

In the measurement of SFF, the same MF membrane as that used in the measurements of SDI and MFF is used. Specifically, a membrane filter having a diameter of 47 mm and a pore size of 0.45 μm is used.

In the measurement of SFF, prior to the measurement of MFF, reference water that does not contain microparticles or biopolymers (normally, RO membrane permeate) is passed through the membrane in order to measure T₀. The SFF of the water sample is calculated using SFF=T₁/T₀.

In the measurement of SFF, the temperatures of the reference water and the water sample are measured down to 0.1° C., and the viscosity of the water is corrected for the temperature of the water.

The reference water is RO membrane permeate that does not contain microparticles or biopolymers and has an electric conductivity of about 1 to 5 mS/m (10 to 50 μS/m).

SFF, the method for measuring SFF, and MFF are described in NPL 1.

While the best MFF, which is an index for measuring microparticles, is 1.00, the best SFF is 0.970 to 0.975.

In other words, the MF membrane permeability may be improved compared with the reference water that does not contain microparticles or biopolymers.

This is presumably because the presence of salts increases the water permeability of a nitro cellulose MF membrane.

FIG. 3 illustrates the results of measurement of the SFF of ultrapure water to which NaCl has been added in order to change the electric conductivity of the water.

The RO membrane permeate used as reference water for measuring T₀ had an electric conductivity of 2.3 mS/m. The ultrapure water had an electric conductivity of less than 0.1 mS/m.

«Indices of Likelihood of RO Membrane Feedwater Fouling Membranes»

Table 1 summarizes the scale for evaluating the indices of the likelihood of RO membrane feedwater fouling membranes. This evaluation scale is described in NPL 1.

The qualities required by RO membrane feedwater are those evaluated as 4 or more.

The qualities required by water fed to an ion-exchange resin are those evaluated as 3 or more. The qualities required by general-purpose treated water are those evaluated as 1 or more.

TABLE 1

| | Evaluations | | | | | |
|---|---|---|---|---|---|---|
| | | Index of | Index of contamination | | | |
| | | contamination due | due to microparticles | | | |
| | | to dissolved | (silt and metal hydroxide colloid) | | | Index of trace |
| | Evaluation as | polymers | | Estimated | | turbidity |
| Grade | RO feedwater | SFF | MFF | SDI | Remarks | net NTU |
| 0 | Unable to | 2.0< | 3.0< | — | | 0.5 or more |
| | permeate | | | | | |
| 1 | Inappropriate to | 1.2-2.0 | 1.3-3.0 | 6.6< | | 0.20-0.49 |
| | permeate | | | | | |
| 2 | Pretreatment | 1.12-1.2 | 1.15-1.3 | 5.64-6.6 | | 0.10-0.20 |
| | needs | | | | | |
| | to be improved | | | | | |
| 3 | Improvement of | 1.08-1.12 | 1.10-1.15 | 4.17-5.64 | | 0.06-0.09 |
| | pretreatment is | | | | | |
| | greatly | | | | | |
| | anticipated | | | | | |
| 4 | Improvement of | 1.04-1.08 | 1.06-1.10 | 3.00-4.17 | In general, | 0.04-0.05 |
| | pretreatment is | | | | SDI of 4.0 or | |
| | anticipated | | | | less is | |
| 5 | Suitable as RO | 1.00-1.04 | 1.025-1.06 | 1.80-3.00 | required. In | 0.02-0.03 |
| | feedwater | | | | KWIMFF | |
| S | Best as | 0.975-09999 | 1.00-1.024 | 1.80> | standard, | 0.00-0.01 |
| | RO feedwater | | | | MFF of 1.1 or | |
| | | | | | less is | |
| | | | | | required. | |

| | |
|---|---|
| net NTU | Value measured with NTU meter 2100Q produced by HACH minus the value of |
| | ultrapure water (0.04 to 0.08) |
| Estimated SDI | Value calculated using MFF-SDI correlation equation |
| Reasons for which Rank | In the case where water sample does not contain a substance detectable with |
| S is SFF of 0.9 to 1.0 | SFF or MFF, the SFF of the water sample is theoretically 1.00 but about 0.98. |
| | This is because the sample contains a larger amount of salts than the |
| | reference water, which increases the water permeability of the MF membrane. |

<Melamine-Formaldehyde Resin Acid Colloidal Solution>

The melamine-formaldehyde resin acid colloidal solution (hereinafter, referred to as “MFRAC”) used in the present invention normally contains 8% to 10% resin component, which is dispersed under an acidic condition to form a positively charged colloid.

MFRAC has been known as a coagulant for 40 years or more but hardly used as a coagulant for wastewater treatment in consideration of the results of overall evaluations on cost effectiveness and the fact that MFRAC always produces formaldehyde as a reaction residue, much less the case or attempt where MFRAC is used in a treatment of industrial water or a treatment for producing clean water for human, such as drinking water.

At the beginning, MFRAC had been used as an additive for imparting water resistance to paper. Afterward, MFRAC was used as an abhesive for excess paint contained in water that circulates through an automotive paint booth.

MFRAC produces advantageous effects in the treatment of excess paint in an automotive paint booth by the following mechanism.

The paint that is to be coagulated and made abhesive in an automotive paint booth is a particular paint that primarily includes microparticles of resin having a melamine skeleton, such as an alkyl melamine resin, a polyester-melamine resin, or an acrylic-melamine resin, which are dispersed in the paint. It is considered that, in the treatment of the automotive paint booth, MFRAC, which is similar to the paint, has a high affinity for the paint and is therefore capable of coagulating the paint and making the coagulated particles to be abhesive.

An example of application of MFRAC other than the treatment of excess paint in an automotive paint booth is using MFRAC as a coagulant for wastewater treatment. PTL 1 proposes a technique in which MFRAC is used as a coagulant for wastewater containing water-soluble starch. Since MFRAC is capable of coagulating water-soluble starch and polyvinyl alcohol, which are difficult to coagulate with PAC, MFRAC is effectively used as a coagulant for wastewater that contains water-soluble starch and polyvinyl alcohol.

However, the reaction ratio between MFRAC and the substances that are to be coagulated with MFRAC exceeds 1:1 in terms of solid content.

If the amount of the substances that are to be coagulated is 100 mg/L and the reaction ratio is 2:1, the amount of MFRAC required is 200 mg/L in terms of resin content. If the resin content in MFRAC is 10%, the amount of MFRAC required is 2000 mg/L on a product basis.

Since about 3000 mg/kg of formaldehyde remains in MFRAC, adding MFRAC in the above amount increases the concentration of formaldehyde in the treated water to 6 mg/L. Furthermore, the treatment costs are increased.

The upper limit for formaldehyde concentration in Japanese tap water is 0.08 mg/L or less. The upper limit is 0.9 mg/L or less according to the WHO recommendations.

Therefore, MFRAC has been hardly used as a coagulant for wastewater treatment, much less the case or attempt where MFRAC is used in a treatment of industrial water or a treatment for producing clean water for human, such as drinking water.

In the case where MFRAC is used in an automotive paint booth, formaldehyde may remain and accumulate in the water circulating through the booth. However, the formaldehyde does not cause problems because the circulating water is not discharged from the booth and the water that circulates through the booth is subjected to an adequate treatment, such as a biological treatment, before being blown out of the booth.

<Cationic Organic Coagulant>

In foreign countries, polydiallyldimethylammonium chloride (hereinafter, referred to as “poly-DADMAC”), which is a cationic organic coagulant, has been used as a coagulant for industrial water in addition to an aluminum salt, such as PAC, even in the case where raw water is taken directly from a river or the like.

In United States, use of poly-DADMAC as a coagulant in clean water production for supplying drinking water is permitted by EPA (The United States Environmental Protection Agency). poly-DADMAC has been widely used also for treating industrial water.

PTL 2 proposes a technique in which a cationic coagulant, such as poly-DADMAC, is added to water circulating through a wet paint booth which contains a water-based paint in order to adjust the amount of electric charge to be a predetermined value.

An example case where MFRAC and a cationic organic coagulant are used in combination is described in PTL 3. Specifically, PTL 3 proposes a method for treating water circulating through a wet paint booth in which a water-based paint and an oil-based paint are present, in which a cationic coagulant and an amino resin acid colloid are added to the water that circulates through the booth while the amount of cationic coagulant is adjusted such that the amount of charge of colloid included in the circulating water is −50 to +100 μeq/L.

In the treatment of excess paint in the booth circulating water, MFRAC and a cationic organic coagulant are used in combination in order to, as described in PTL 3, neutralize the charge of microparticles of the paint, which are negatively charged and stable, and coagulate the microparticles.

The degree of neutralization of charge achieved using an organic cationic coagulant has been assessed formerly by colloid titration, in which the end point is determined in accordance with a change in color tone with an indicator. Recently, the degree of neutralization of charge has been determined by titration in which streaming potential is measured.

The streaming potential method is capable of conducting measurement in a low-concentration range within a short period of time with an apparatus “PCD” (particle charge detector). Specifically, a low concentration of about 0.1 μeq/L (0.02 mg/L in terms of poly-DADMAC concentration) in terms of colloid equivalent (amount of charge of colloidal particles) can be measured.

Theoretically, changing the amount of charge of colloid to be zero is considered to be an optimum coagulation treatment.

In the treatment of booth circulating water in PTL 3, when the appropriate amount of cationic organic coagulant is used, the amount of charge of colloid subsequent to the addition and reaction is −50 to 100 μeq/L. In PTL 2, this value is −100 to 1000 μeq/L. Although the distribution of the appropriate range shifts to positive side across the zero point and the negative-side portion of the distribution is narrow, the zero point is still the appropriate point, which agrees with the general theory.

PTL 1: Japanese Patent Publication S60-129184 A

PTL 2: Japanese Patent Publication 2002-79263 A

PTL 3: Japanese Patent Publication 2006-61776 A

NPL 1: “Bunri Gijyutsu (Separation Process Engineering)”, Vol. 45, 4 (2015), feature article: Fundamental and Practice of Solid-Liquid Separation “Proposal of Novel Index of Likelihood of Reverse Osmosis Membrane Feedwater Fouling Membrane”

A coagulation treatment using an aluminum salt composed primarily of PAC has the following issues.

(1) It is difficult to produce treated water that can be suitably used as RO membrane feedwater, which is required to have high clarity.

(2) Since a large amount of coagulated flocs are produced, in the case where direct filtration is performed, the amount of PAC added to water is limited in accordance with the amount of load placed on a filtering device. Consequently, the clarity of the treated water may become degraded.

(3) When PAC is added to water in an amount at which PAC is normally used, aluminum hydroxide colloidal particles may pass through a filtration device and remain in the treated water. Specifically, as illustrated in FIG. 4, the results of measurement of netNTU (turbidity) of the filtrate confirm that clear water is produced when 15 mg/L of PAC is used. However, the amount of aluminum colloid contained in the filtrate is 100 μg/L or more.

As for aluminum remaining in the treated water, in the case where the treated water is fed to an RO membrane in order to perform desalination, aluminum hydroxide alone and aluminum hydroxide reacted with silica may clog the RO membrane.

Aluminum that remains in the water coagulated and filtered with PAC is described below.

As described above, the primary objective of the coagulation and filtration treatment of industrial water is to reduce the turbidity of the industrial water.

However, even under the conditions where considerably high clarity that corresponds to a turbidity of less than 0.05 netNTU is achieved, the amount of remaining aluminum included in the filtrate in the form of an aluminum hydroxide colloid increases compared with that in the industrial water that has not been treated.

FIG. 4 is a graph illustrating the relationship between the Al content in clarified water and the amount of PAC used and the relationship between the netNTU (turbidity) of the clarified water and the amount of PAC used, the clarified water being the filtrate produced by coagulating the industrial water of Ukishima district, Kawasaki, Kanagawa with PAC and filtering the coagulated water through a two-ply filtration paper sheet No. 5A having a diameter of 185 mm (hereinafter, this filtrate may be referred to as “No. 5A two-ply filtrate”).

The microparticle-capturing effect of the filtration treatment using the two-ply filtration paper sheet No. 5A having a diameter of 185 mm stands midway between that of two-layer gravity filtration capable of filtering sand particles having a diameter of 0.45 mm and that of two-layer pressure filtration capable of filtering sand particles having a diameter of 0.60 mm.

The results illustrated in FIG. 4 confirm the following facts.

The results of measurement of the netNTU (turbidity) of the filtrate confirm that, when 12 mg/L of PAC is used, the netNTU of the filtrate is reduced to be less than 0.03, which is a quality sufficient in the treatment of common industrial water.

However, the amount of aluminum that remains in the filtrate is increased; when 12 mg/L of PAC is used, the amount of aluminum that remains in the filtrate is maximized, that is, increased to 120 μg/L (0.12 mg/L), which is twice or more the amount of aluminum that remains in the filtrate when coagulation is not performed using PAC (PAC: 0 mg/L), that is, 55 μg/L (0.055 mg/L).

It is not possible to reduce the amount of aluminum that remains in the filtrate to the level at which aluminum is included in industrial raw water even when the amount of PAC added is increased to 30 mg/L.

As described above, the addition of 10 to 12 mg/L of PAC is necessary for achieving low turbidity (low netNTU), which is the primary objective of the treatment of industrial water. On the other hand, when the amount of PAC used is increased from 0 mg/L to 12 mg/L, the amount of aluminum that remains in the filtrate disadvantageously increases in proportion to the amount of the PAC added.

It is considered on the basis of the results illustrated in FIG. 4 that about 50 mg/L or more of PAC needs to be used for reducing the amount of aluminum that remains in the filtrate to the level at which aluminum is included in the industrial raw water. This increases the costs for chemicals and disposal of sludge. Furthermore, the amount of flocs produced is increased. Consequently, it becomes not possible to directly filtrate the coagulated water.

It is particularly disadvantageous that the amount of remaining aluminum exceed 100 μg/L in the case where the treated water is used as RO membrane feedwater.

Even in the case where a ferric salt, such as ferric chloride, is used as an inorganic coagulant, iron hydroxide colloidal particles may remain in the treated water when the amount of the ferric salt added is not sufficiently large.

While the aluminum hydroxide colloid is hardly detected as netNTU, the iron hydroxide colloid is easily detected as netNTU. The presence of iron hydroxide colloid is confirmed by the MF filtration paper that has been used in the measurement of SFF and MFF turning yellow or brown.

### SUMMARY OF INVENTION

An objective of the present invention is to provide a method and an apparatus for clarifying industrial water that enable industrial water to be highly clarified with a small amount of coagulant instead of an inorganic coagulant, such as PAC, aluminum sulfate, or ferric chloride, which needs to be used in a large amount for clarifying industrial water, and are capable of producing treated water having qualities particularly suitable for an RO membrane treatment.

Another objective of the present invention is to provide a method and an apparatus for clarifying industrial water that are capable of reducing the amount of coagulant added to water and, accordingly, the volume of coagulated flocs, producing treated water having a high degree of clarification by feeding the coagulated water directly to an MF or UF membrane module, or a pressure or gravity filtration device without subjecting the coagulated water to solid-liquid separation using a sedimentation separation device or a floatation separation device prior to the filtration treatment, and limiting an increase in the amount of remaining aluminum.

The inventor of the present invention found that it is possible to produce treated water having good qualities that correspond to a grade of 4 or more on the scale described in Table 1 by using a melamine-formaldehyde resin acid colloidal solution (MFRAC) as a coagulant for industrial water in a markedly small amount compared with PAC and filtering the coagulated water through the No. 5A two-ply filter.

Examples of substances contained in industrial water which are to be coagulated include clay microparticles composed primarily of silica and micro-gelatinous polysaccharide metabolites (i.e., biopolymers) produced by microorganisms such as algae, which are soluble and capable of passing through 1-μm micropores that correspond to a double-layer gravity or pressure filtration device. The above substances that are to be coagulated are clearly different from the excess paint components in an automotive paint booth, which have been removed using MFRAC.

Therefore, it is not possible to devise a method of using MFRAC for coagulating industrial water on the basis of the technique known in the related art in which the excess paint is removed from an automotive paint booth with MFRAC. There has been neither case study nor attempt in which MFRAC is used for coagulating industrial water.

The summary of the present invention is as follows.

[1] A method for clarifying industrial water, the method comprising:

adding a melamine-formaldehyde resin acid colloidal solution to industrial water whereby coagulating the industrial water; and

subsequently filtering the coagulated water.

[2] The method for clarifying industrial water according to [1], the method further comprising adding a cationic organic coagulant to the industrial water prior to the addition of the melamine-formaldehyde resin acid colloidal solution.

[3] The method for clarifying industrial water according to [2], wherein the amount of the cationic organic coagulant added is 70% or less of the amount of cation included in the cationic organic coagulant, the cation being consumed by the industrial water, the amount of cation being determined by a streaming potential method.

[4] The method for clarifying industrial water according to [2] or [3], wherein the cationic organic coagulant is polydiallyldimethylammonium chloride.

[5] The method for clarifying industrial water according to any one of [1] to [4], wherein the pH of the industrial water is adjusted to be 7 or more in the coagulation treatment by aerating the industrial water or adding an alkali to the industrial water.

[6] The method for clarifying industrial water according to any one of [1] to [5], wherein the coagulated water is directly filtered with a pressure or gravity filtration device without being subjected to solid-liquid separation using a sedimentation separation device or a floatation separation device prior to the filtration treatment.

[7] The method for clarifying industrial water according to any one of [1] to [5], wherein the coagulated water is directly filtered with a microfiltration membrane module or an ultrafiltration membrane module without being subjected to solid-liquid separation using a sedimentation separation device or a floatation separation device prior to the filtration treatment.

[8] The method for clarifying industrial water according to any one of [1] to [7], wherein filtrate produced by the filtration treatment is further treated through a reverse osmosis membrane.

[9] An apparatus for clarifying industrial water, the apparatus comprising a coagulation unit that adds a melamine-formaldehyde resin acid colloidal solution to industrial water in order to coagulate the industrial water, and a filtration unit through which coagulated water produced in the coagulation unit is filtered.

[10] The apparatus for clarifying industrial water according to [9], wherein the coagulation unit adds a cationic organic coagulant to the industrial water prior to the addition of the melamine-formaldehyde resin acid colloidal solution.

[11] The apparatus for clarifying industrial water according to [10], wherein the amount of the cationic organic coagulant added in the coagulation unit is 70% or less of the amount of cation included in the cationic organic coagulant, the cation being consumed by the industrial water, the amount of cation being determined by a streaming potential method.

[12] The apparatus for clarifying industrial water according to [10] or [11], wherein the cationic organic coagulant is polydiallyldimethylammonium chloride.

[13] The apparatus for clarifying industrial water according to any one of [9] to [12], the apparatus further comprising a pH-control unit that adjusts the pH of the industrial water to be 7 or more in the coagulation unit by aerating the industrial water or adding an alkali to the industrial water.

[14] The apparatus for clarifying industrial water according to any one of [9] to [13] wherein the filtration unit is a pressure or gravity filtration device, and wherein the coagulated water is directly introduced to the filtration unit without being subjected to solid-liquid separation using a sedimentation separation device or a floatation separation device prior to the filtration unit.

[15] The apparatus for clarifying industrial water according to any one of [9] to [13], wherein the filtration unit is a microfiltration membrane module or an ultrafiltration membrane module, and wherein the coagulated water is directly introduced to the filtration unit without being subjected to solid-liquid separation using a sedimentation separation device or a floatation separation device prior to the filtration unit.

[16] The apparatus for clarifying industrial water according to any one of [9] to [15], the apparatus further comprising a reverse osmosis membrane module in which filtrate produced in the filtration unit is further treated through a reverse osmosis membrane.

### Advantageous Effects of Invention

According to the present invention, using MFRAC as a coagulant in the coagulation and filtration of industrial water enables consistent and efficient treatment of the industrial water due to the following actions and advantageous effects.

(1) Treated water having high clarity may be produced using a coagulant in an amount small enough to directly filter the coagulated water. This reduces the volume of flocs produced from the coagulant.

(2) Treated water having high clarity which is suitably used as RO membrane feedwater may be produced.

(3) The above advantages (1) and (2) may be achieved without using an aluminum-based coagulant. This prevents formation of hydroxide colloidal particles in the treated water and an increase in the amount of hydroxide colloidal particles.

(4) For the reason described in (3), it is possible to produce desalted water consistently by reducing leakage of aluminum and formation of scale as a result of aluminum bonding to ionic silica which may occur when the treated water is fed to an RO membrane in the production of the desalted water.

### BRIEF DESCRIPTION OF DRAWINGS

FIG. 1 is a graph illustrating the correlation between MFF and SDI.

FIG. 2 is a graph illustrating the correlation between MFF and SDI.

FIG. 3 is a graph illustrating the correlation between electric conductivity and SFF.

FIG. 4 is a graph illustrating the relationship between the amount of PAC used in the coagulation and filtration of industrial water and the amount of Al remaining in filtrate, and the relationship between the amount of PAC used in the coagulation and filtration of industrial water and the netNTU of the filtrate.

FIG. 5 is a graph illustrating the relationships between the amounts of chemicals used in the coagulation and filtration of industrial water I and the SFF of filtrate.

FIG. 6 is a graph illustrating the relationships between the amounts of chemicals used in the coagulation and filtration of industrial water I and the MFF of filtrate.

FIG. 7 is a graph illustrating the relationships between the amounts of chemicals used in the coagulation and filtration of industrial water I and the netNTU of filtrate.

FIG. 8 is a graph illustrating the relationships between the amounts of chemicals used in the coagulation and filtration of industrial water I and the ultraviolet absorbance of filtrate.

FIG. 9 is a graph illustrating the relationships between the amounts of chemicals used in the coagulation and filtration of industrial water II and the SFF of filtrate.

FIG. 10 is a graph illustrating the relationships between the amounts of chemicals used in the coagulation and filtration of industrial water II and the MFF of filtrate.

FIG. 11 is a graph illustrating the relationships between the amounts of chemicals used in the coagulation and filtration of industrial water III and the SFF of filtrate.

FIG. 12 is a graph illustrating the relationships between the amounts of chemicals used in the coagulation and filtration of industrial water III and the MFF of filtrate.

FIG. 13 is a graph illustrating the relationship between the amount of MFRAC added to industrial water II and the streaming potential measured.

FIG. 14 is a graph illustrating the relationships between the amount of Poly-DADMAC (“Zeta Ace P702” produced by Kurita Water Industries Ltd.) added to industrial water I in the coagulation and filtration of the industrial water I in the case where the amount of MFRAC added was 7 mg/L and the SFF and MFF of filtrate.

FIG. 15 is a graph illustrating the relationships between the amount of MFRAC added to industrial water I in the coagulation and filtration of the industrial water I in the case where the amount of Poly-DADMAC (“Zeta Ace P702” produced by Kurita Water Industries Ltd.) added was 0.2 mg/L and the SFF and MFF of filtrate.

FIG. 16 is a graph illustrating the relationships between the amount of Poly-DADMAC (“Zeta Ace P702” produced by Kurita Water Industries Ltd.) added to industrial water III in the coagulation and filtration of the industrial water III in the case where the amount of MFRAC added was 10 mg/L and the SFF and MFF of filtrate.

FIG. 17 is a graph illustrating the relationships between the amount of MFRAC added to industrial water III in the coagulation and filtration of the industrial water III in the case where the amount of Poly-DADMAC (“Zeta Ace P702” produced by Kurita Water Industries Ltd.) added was 0.7 mg/L and the SFF and MFF of filtrate.

FIG. 18 is a graph illustrating the relationships between the amount of MFRAC used in the coagulation and filtration of the city water of Nogi-machi, Tochigi, and the SFF and MFF of the filtrate.

FIG. 19 is a graph illustrating the relationships between the amount of MFRAC used in the coagulation and filtration of permeate prepared by passing the city water of Nogi-machi, Tochigi, through an MF membrane and the SFF and MFF of the filtrate.

FIG. 20a is a graph illustrating the relationship between the pH of the city water of Nogi-machi, Tochigi, containing 10 mg/L of MFRAC which is measured in the coagulation and filtration treatments and the SFF of the filtrate, and FIG. 20b is a graph illustrating the relationship between the above pH and the MFF of the filtrate.

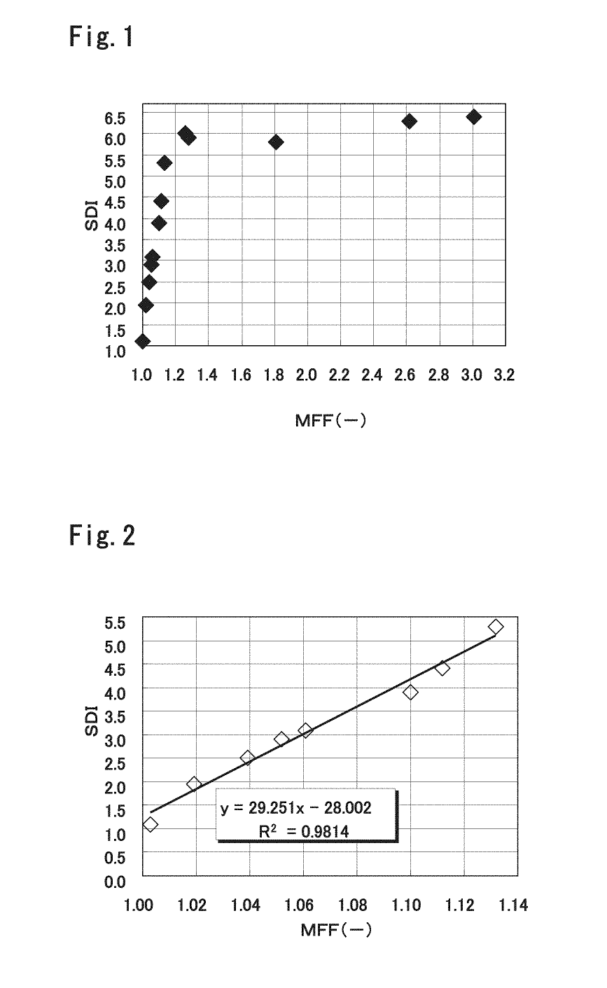

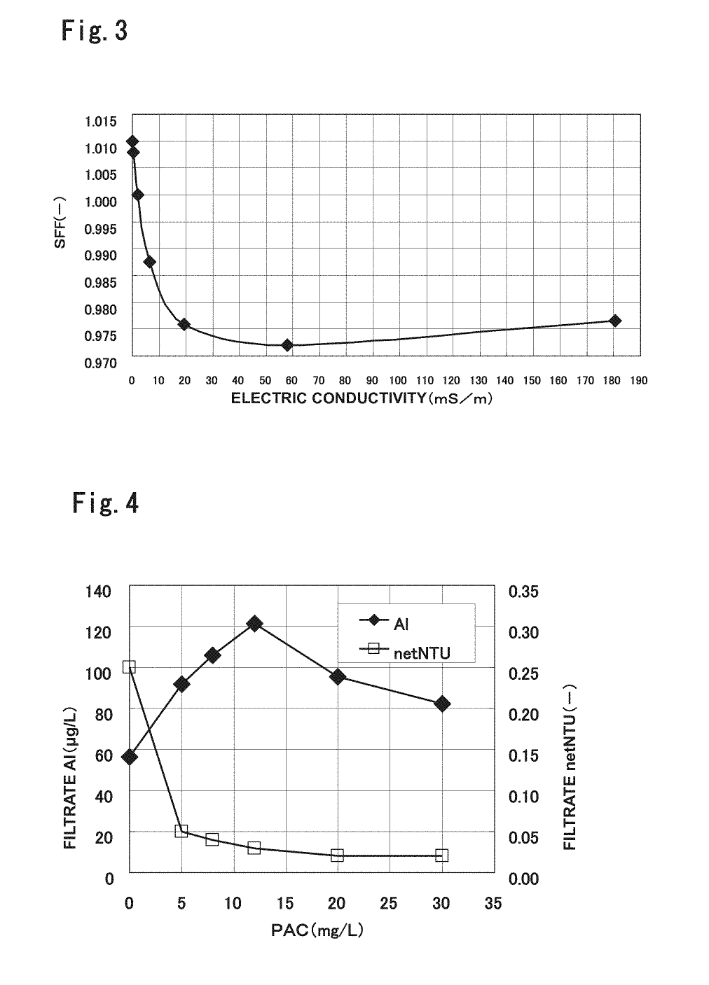

### DESCRIPTION OF EMBODIMENTS

Embodiments of the present invention are described below in detail.

In the present invention, a melamine-formaldehyde resin acid colloidal solution (MFRAC) is used as a coagulant in the coagulation and filtration of industrial water; an inorganic coagulant, such as PAC, is not used. A cationic organic coagulant may be optionally used in combination with MFRAC as an adjuvant for reducing the amount of MFRAC required.

MFRAC has been used as a coagulant but not used in the coagulation of industrial water for the following reasons.

(1) Normally, MFRAC has been considered to have the same effects as PAC, which is an inorganic coagulant.

(2) MFRAC costs approximately ten times or more as much as PAC.

(3) Since MFRAC contains formaldehyde in a proportion of 3000 mg/kg, theoretically, the maximum limit of 0.08 mg/L for Japanese tap water is reached when MFRAC is used at a concentration of 267 mg/L.

As described above, it is the primary objective of treating industrial water to reduce the turbidity (netNTU) of the industrial water. The secondary objective is, for example, to reduce the amount of organic substances, such as humic substances.

The reason (1) above is specifically described below.

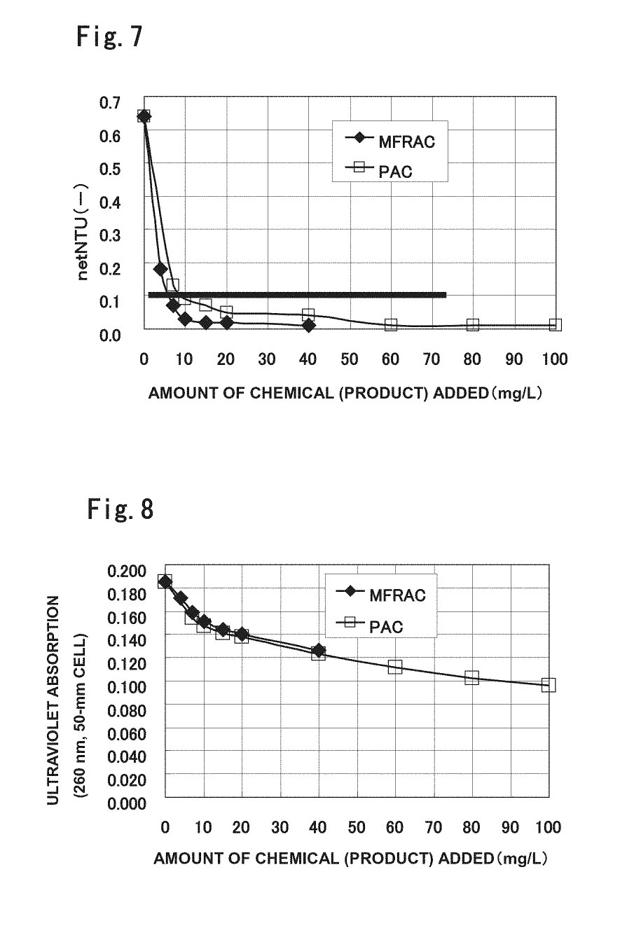

As shown by the results illustrated in FIGS. 7 and 8 which were obtained in Test Example 1 below, the results of measurement of netNTU and ultraviolet absorbance confirm that MFRAC has substantially the same effects as PAC on a product basis. Therefore, when an assessment is made in accordance with netNTU and ultraviolet absorbance, MFRAC is considered not useful because of the significant difference in unit price.

It is considered that reducing netNTU to 0.10 be sufficient for using the treated water in general applications with no trouble, except for the leakage of aluminum, clogging of nozzles, or the like.

Accordingly, it may be possible to reduce the amount of MFRAC added to industrial water to about half the amount of PAC required. However, considering that the unit price of MFRAC is ten times or more that of PAC, using MFRAC has been considered insignificant in the evaluations made in the related art.

The curve that represents the ultraviolet absorbance of filtrate that contains MFRAC, which is an index of humic organic substances, extends along the curve that represents the ultraviolet absorbance of filtrate that contains PAC as illustrated in FIG. 8. This confirms that MFRAC has substantially the same effects as PAC.

When the ultraviolet absorbance of filtrate is about 0.300 or more, the treated water may become lightly stained or an RO membrane may become clogged. The ultraviolet absorbance of treated water produced by coagulation and filtration of the industrial water commonly used in Japan hardly exceeds 0.300. Humic substances assessed with the absorbance can be removed through an RO membrane or by ion exchange.

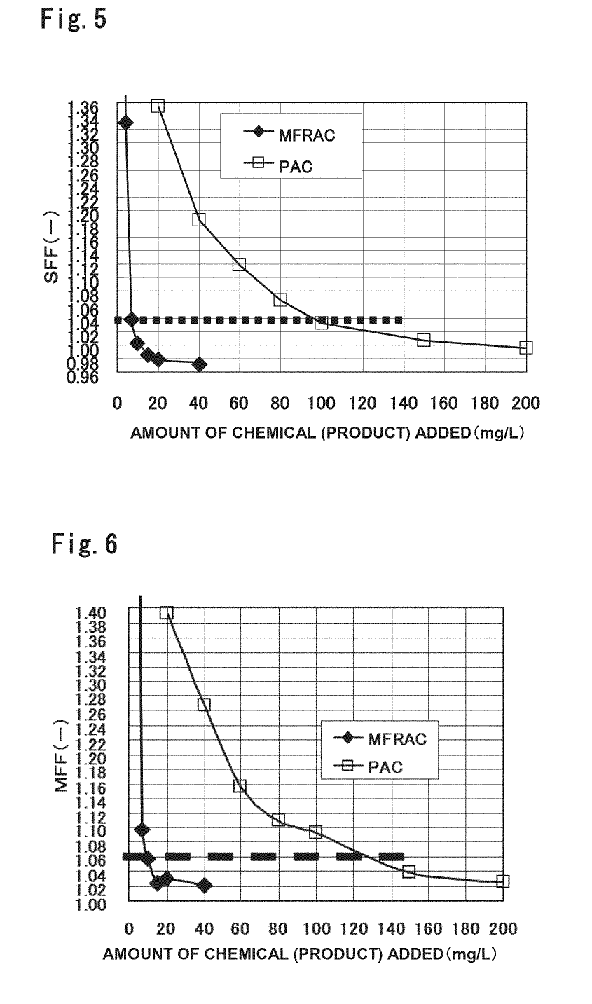

The advantageous effects of MFRAC confirmed by the results illustrated in FIGS. 5 and 6 which were obtained in Test example 1 below were achieved as a result of the inventor of the present invention considering the properties of MFRAC while developing a detailed method for evaluating the high clarity required by RO membranes (Table 1 above) and studying the properties of MFRAC and the evaluation method in a comprehensive and deep manner.

The MFRAC used in Test examples and Examples below is “Kuristuck B100” produced by Kurita Water Industries Ltd., which is a commercially available agent for treating excess paint in an automotive paint booth.

The MFRAC resin content in B100 is about 9%. The solid content in B100 dried at 105° C. is 9.3%.

Since a melamine resin is capable of adsorbing polysaccharides and silt microparticles thereon, an acid colloid having a resin skeleton further including an amino resin other than melamine, such as urea, as cocondensation component may also be used in this application. For the same reason, an alkyl melamine resin acid colloid may also be used.

The condensation agent is not limited to formaldehyde; an acid colloid including an alkylaldehyde, glyoxal, or para-formaldehyde may also be used.

Although MFRAC is a cationic colloid, the power of MFRAC to neutralize the charge of anionic colloidal particles contained in industrial water is considerably low.

The above property of MFRAC is advantageous when the coagulated water is filtered through a UF membrane or an MF membrane and the filtrate is fed to an RO membrane, because the treatment using MFRAC does not change the streaming charge of the liquid system to be zero or positive. It is preferable to use a cationic organic coagulant in combination in order to eliminate part of the charge of the anionic colloidal particles and reduce the amount of MFRAC required by the treatment.

<Industrial Water>

The industrial water that is to be treated in the present invention is surface water, such as river water, lakes, dam lakes, and reservoirs, which is used as raw water and clarified by coagulation, filtration, or the like for producing industrial or city water and may be water fed to a company after being subjected to simple coagulation and filtration treatments in a water treatment plant. Note that, the industrial water that is to be treated in the present invention does not include well water or spring water.

The present invention is particularly effective for treating industrial water that requires a large amount of PAC for clarification and has a relatively high degree of contamination.

[MFRAC]

Any commercially available MFRAC is suitably used. In the case where MFRAC is produced, for example, the following production method may be employed.

MFRAC is produced by reacting melamine with an aldehyde and adding an acid to the resulting methylol melamine. Alternatively, the methylol melamine may be converted into an alkyl ether before the addition of the acid.

Examples of the aldehyde include formaldehyde, para-formaldehyde, acetaldehyde, and propionaldehyde. Among these, in particular, formaldehyde and para-formaldehyde are preferable in terms of reaction efficiency and ease of handling.

The proportions of the melamine and the aldehyde used in the production of the methylol melamine are preferably set such that the amount of aldehyde is 1 to 6 moles relative to 1 mole of melamine. If the amount of aldehyde is more than 2.5 moles relative to 1 mole of melamine, the amount of free aldehyde groups contained in the acid colloidal solution is large. Accordingly, the amount of aldehyde is preferably 2.5 moles or less relative to 1 mole of melamine.

Methylol melamine is insoluble in water but dissolves in an acidic solution to form a colloidal solution. Alkylated methylol melamine, which is produced by converting methylol melamine into an alkyl ether, is soluble in water and forms a colloidal solution when an acid is added to the alkylated methylol melamine.

A monobasic acid is suitably used as an acid. Specific examples of the monobasic acid include mineral acids, such as hydrochloric acid and nitric acid, and organic acids, such as formic acid, acetic acid, lactic acid, and propionic acid. Among these, in particular, hydrochloric acid is preferable because it increases the stability of the colloidal solution.

The amount of monobasic acid used and, in particular, the amount of hydrochloric acid are suitably about 0.5 to 1.5 moles and is preferably 0.7 to 1.3 moles relative to 1 mole of melamine.

Although a large amount of free aldehyde groups are present at the initial stage of the preparation of the colloidal solution, the amount of free aldehyde decreases while the colloidal solution is left to stand and ages. It is adequate to age the colloidal solution for about 5 days to 3 months when the colloidal solution is left at room temperature and for about 2 to 3 hours at 50° C. when the colloidal solution is heated.

The content of the melamine-formaldehyde resin (i.e., the melamine-aldehyde condensation product) in the acidic solution of the melamine-formaldehyde resin is normally 5% to 20% by weight. The pH of the acidic solution is about 1.5 to 2.5.

The molecular weight of the melamine-formaldehyde resin used in the present invention is preferably 400 to 10,000,000 and is particularly preferably 1,000 to 100,000. The higher the molecular weight of the melamine-formaldehyde resin, the larger the coagulation effect. However, if the molecular weight of the melamine-formaldehyde resin is excessively high, it becomes difficult to dissolve the melamine-formaldehyde resin in the preparation of the acidic solution.

The size of colloidal particles included in the acid colloidal solution of the melamine-formaldehyde resin used in the present invention is preferably 10 to 70 nm and is particularly preferably 20 to 50 nm. The larger the size of the colloidal particles, the larger the coagulation effect. However, if the size of the colloidal particles is excessively large, the total surface area of the colloidal particles becomes small, which may reduce the treatment efficiency. The sizes of colloidal particles included in the acid colloidal solution of the melamine-formaldehyde resin are measured by, for example, dynamic light scattering and the average size of the colloidal particles is calculated.

The amount of MFRAC added to industrial water is not limited and may be set appropriately such that a suitable coagulation effect is achieved. The amount of MFRAC added to industrial water is 0.2 mg/L-R or more and 3.0 mg/L-R or less in terms of resin component (hereinafter, the amount (mg/L) of MFRAC added in terms of resin component is described in “mg/L-” unit). The amount of MFRAC added to industrial water is preferably determined in accordance with the qualities of the industrial water (e.g., the types and concentrations of contaminants (i.e., the substances that are to be coagulated)), whether or not a cationic organic coagulant is used in combination with MFRAC, and the objectives for the treatment (e.g., whether or not the treated water is fed to an RO membrane).

If the amount of MFRAC used is excessively small, a sufficient coagulation effect may fail to be achieved. If the amount of MFRAC used is excessively large, the likelihood of the coagulated water fouling membranes may be increased. In particular, in the case where MFRAC is used in combination with a cationic organic coagulant, the amount of MFRAC used is preferably adjusted to be 0.2 to 2.0 mg/L-R and is particularly preferably adjusted to be 0.3 to 1.3 mg/L-R.

<Cationic Organic Coagulant>

Adding a cationic organic coagulant to industrial water to coagulate the industrial water prior to the addition of MFRAC for the coagulation treatment enables a reduction in the amount of MFRAC required by the treatment, which is more expensive than PAC. This advantageously reduces the treatment cost, the amount of coagulated flocs, and the load placed on a filter when the industrial water is directly filtered.

Any type of cationic organic coagulant may be used since all cationic organic coagulants are capable of neutralizing charge and have a coagulating force.

Commercially available cationic organic coagulants which are popular worldwide are classified into the following two types: P702 (poly-DADMAC) synthesized by polymerization; and a epichlorohydrin/dialkylamine condensation product synthesized by condensation.

Alternatively, dimethylamino methacrylate (DAM) and a dimethylamino acrylate (DAA) polymer, which are synthesized by polymerization, copolymers thereof, and polyvinylamine (the Hofmann degradation product of polyacrylamide) may be used, although they are not widely used as a cationic organic coagulant.

Methyl glycol chitosan (MGCh), which is used as a reagent for colloid titration, has a high coagulating power but is not useful in practical use because MGCh is an expensive analytical reagent.

The efficiency of the cationic organic coagulant, that is, the amount of cation required for eliminating streaming charge, varies with the structure of the cationic organic coagulant. Among the above two types of commercial cationic organic coagulants, poly-DADMAC has the highest efficiency.

As for the molecular weight of the cationic organic coagulant, cationic organic coagulants (DAM and DAA) that have a molecular weight of several millions or more and are used as an agent for dehydrating sludge, which have an intrinsic viscosity of more than 4 dL/g in a 1 normality solution of sodium nitrate, unfavorably have low reactivity. Therefore, these types of cationic organic coagulants need to have an intrinsic viscosity of about 1 dL/g or less.

The intrinsic viscosity of the condensation-type cationic organic coagulant, which is an index of molecular weight, is less than 0.5 dL/g in consideration of the mechanism of synthesis. This is in an effective range in terms of molecular weight.

The molecular weight of the cationic organic coagulant, such as poly-DADMAC, is preferably set such that the intrinsic viscosity of the cationic organic coagulant in the 1 normality solution of sodium nitrate is about 0.3 to 1.0 dL/g.

The amount of cationic organic coagulant added, such as poly-DADMAC, is preferably set to 70% or less of the amount of cation included in the cationic organic coagulant which is consumed by industrial water and measured by a streaming potential method.

As described above, the amount of cationic organic coagulant at which the amount of charge of colloidal particles reaches zero is considered appropriate in the treatment of an automotive paint booth. The inventor of the present invention found that the zero point at which the amount of charge of colloidal particles reaches zero is not appropriate in the treatment of industrial water and that it is appropriate to use the cationic organic coagulant in an amount smaller than the amount that corresponds to the zero point.

Accordingly, in the present invention, the amount of cationic organic coagulant added is set to the amount that corresponds to 70% or less, that is, for example, 20% to 50%, of the amount of cation included in the cationic organic coagulant which is consumed by the industrial water and measured with a PCD (particle charge detector). This enables suitable coagulation effects to be achieved in the following manner.

In the case where the cationic organic coagulant is used in combination, it is important not to increase the negative charge of the industrial water that is to be coagulated to zero.

Specifically, the amount of cationic organic coagulant used is set 70% or less and preferably set to 20% to 50% of the amount of cationic organic coagulant which is required (consumed) for eliminating streaming charge and measured by PCD.

This is quite different from the theory that an appropriate coagulation treatment is achieved when the amount of streaming charge is around zero.

The first reason for which the amount of the cationic organic coagulant is set to an amount sufficiently smaller than that required for eliminating the charge is that it is confirmed that sufficiently advantageous effects are achieved by adding the cationic organic coagulant in an amount sufficiently smaller than that required for eliminating the charge and eliminating the charge may degrade the advantageous effects.

The second reason is that, since the filtration membranes, such as a UF membrane and an MF membrane, through which the coagulated water is filtered are negatively charged, uncharged or positively charged coagulated particles are likely to adhere to and foul the membranes.

The third reason is that, in the case where filtrate of a two-layer gravity filtration device or a two-layer pressure filtration device is fed to an RO membrane, negatively charged microparticles leaked from the filtration device and biopolymer gel microparticles may associate with the reaction product of the cationic organic coagulant which still have reaction activity and then adhere to the RO membrane, which inhibits the permeation of water. When the cation does not have reaction activity, the above association is not likely to occur even in the case where the microparticles are leaked.

<Coagulation Treatment Method>

In the case where the coagulation treatment of industrial water is performed by adding only MFRAC to the industrial water, it is preferable to add the required amount of MFRAC and stir the resulting mixture for about 5 to 20 minutes in order to perform coagulation. The mixture may be left stand without stirring when the chemical has been diffused to a sufficient degree at the initial stage.

In the case where the cationic organic coagulant is used in combination with MFRAC, it is preferable to add the cationic organic coagulant to industrial water in the required amount, stir the resulting mixture for about 1 to 3 minutes in order to perform coagulation, subsequently add MFRAC to the mixture, and stir the mixture for about 5 to 20 minutes in order to perform coagulation.

<pH Condition for Coagulation Treatment>

The pH condition under which the coagulation treatment is performed is not limited. When the pH of the industrial water is 7 or more, suitable coagulation effects may be achieved while the risk of the addition of excessive amount of MFRAC causing problems is eliminated.

From the above viewpoint, in the case where the pH of the industrial water is less than 7, it is preferable to adjust the pH of the coagulation system to be 7 or more, that is, for example, 7.0 to 8.2, by addition of an alkali, diffusion of carbon dioxide by aeration, or the like.

As described above, it is possible to make the full use of the advantages of the present invention in the case where the degree of contamination of the industrial water is relatively high and the amount of PAC required by the clarification of industrial water is large.

Highly contaminated industrial water typically has a high alkalinity of 40 to 90 mg/L and has a coagulation pH sufficiently higher than 7.

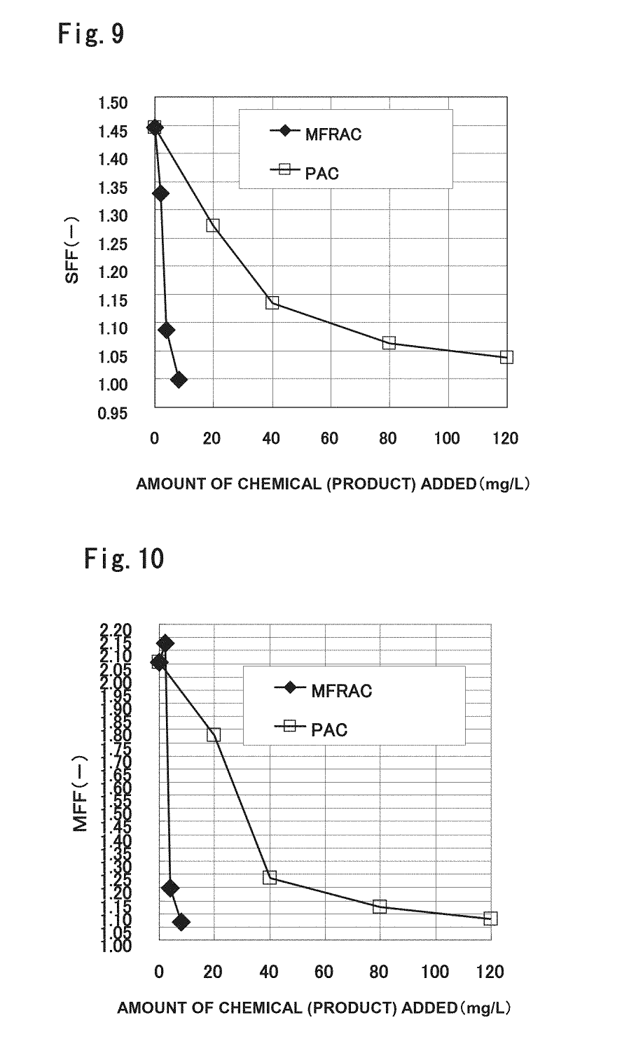

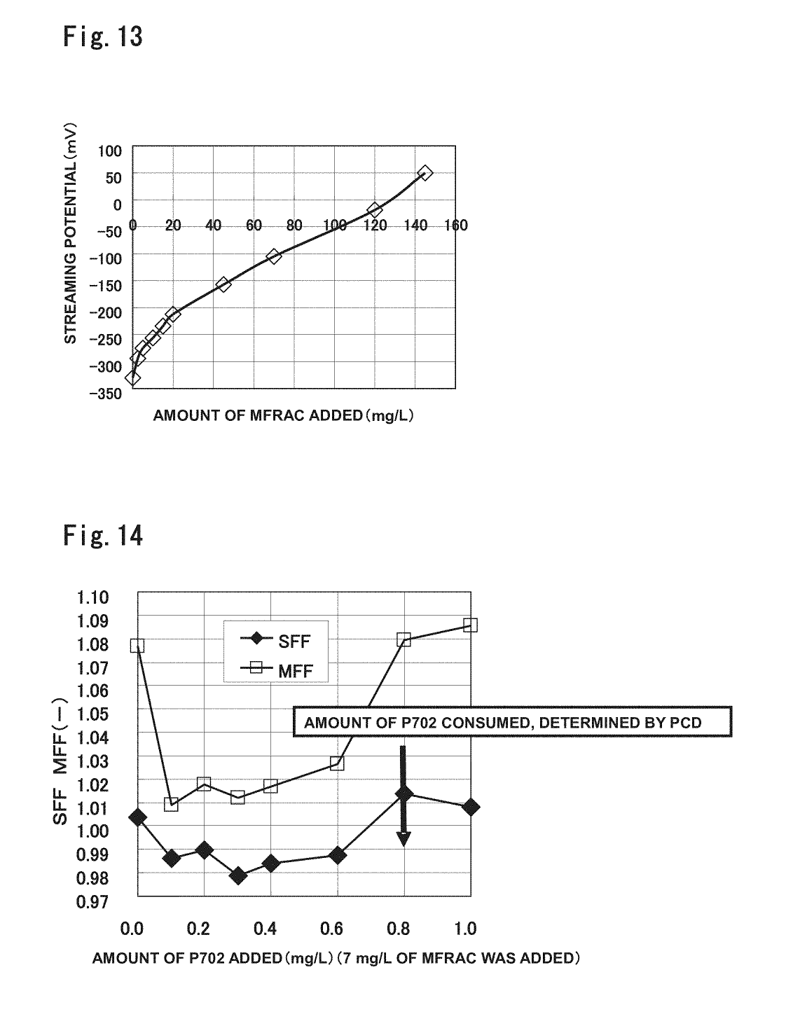

Since such industrial water is industrial water that can be coagulated to a sufficient degree by the addition of 8 mg/L of MFRAC as illustrated in FIGS. 9 and 10 below, it is considered that the problems resulting from the excessive addition of MFRAC do not occur normally, because the amount of MFRAC used at which the amount of streaming charge is zero is 128 mg/L as illustrated in FIG. 13 below.

However, there exists low-alkalinity industrial water having an average alkalinity of 10 to 20 mg/L and a pH of 6 to 7. It is considered that the amount of cationic coagulant consumed by such water is considerably small.

Even in such a case, it is possible to prevent the formation of coagulated particles that are not grown sufficiently with MFRAC by adding a certain amount of MFRAC appropriate to the turbidity of the industrial raw water. However, it is preferable to adjust the pH of the water to be sufficiently higher than 7 in order to enhance the consistency of the treatment.

Even in the case where industrial water has a high alkalinity, that is, a pH greatly exceeding 7, the pH of the industrial water may become less than 7 when the industrial water is markedly clarified due to heavy rain or the treatment that has been performed in the water treatment plant with a large amount of PAC. Therefore, in preparation for the above cases, it is preferable to install an alkali-addition facility or an aeration pipe in an industrial raw water tank or a coagulation reaction tank in order to adjust pH.

<Reduction in Amount of Flocs Due to Coagulant>

Flocs coagulated with PAC are considerably bulky and have a large volume.

The amount of sludge prepared by the inventor of the present invention concentrating aluminum hydroxide, which was produced from 5 g/0.5 L (10000 ppm) of PAC, by gravity and subjecting the concentrated aluminum hydroxide to centrifugal separation with a tabletop centrifugal separator at 3000 rpm for 5 minutes was 40 g, which is 8 times the weight of PAC used.

The amount of SS dried at 105° C. was 0.765 g (15.3% of PAC: 2% as moisture content).

It was confirmed that the amount of dried SS agreed with the form of aluminum hydroxide (Al(OH)₃) and is not aluminum oxide (Al₂O₃: 10.2% of the PAC used).

In the same manner as above, the MFRAC (evaporation residue: 9.3%) used in the evaluation test described below was analyzed. The amount of flocs prepared from 5 g of MFRAC by centrifugal concentration was 35 g, which is 7 times the amount of MFRAC used. The amount of SS dried at 105° C. was 0.417 g (8.35% of MFRAC). Although there is not much difference between MFRAC and PAC, reducing the amount of MFRAC used may significantly reduce the amount of flocs.

The volume of flocs produced when 20 mg/L of PAC, which is the maximum amount of PAC that can be used in two-layer gravity concentration or two-layer gravity concentration, is added to the water is considered to be

20×8=160 μL/L (160 mg/L)

assuming that the volume of flocs produced by centrifugal concentration described above is equal to the density of flocs in an actual filtration layer.

This is considerably large amount (volume) compared with the amount of SS of the industrial water (1 to 5 mg/L, assuming that it is equal to 1 to 5 degrees of turbidity).

Even assuming that the SS contained in the industrial water are present in the form of hydrate and the volume of hydrate present in the filtration layer be 10 times the volume of the SS (concentration: 10%), the volume of the SS is 10 to 50 μL/L (10 to 50 mg/L), which is 3 to 15 times the volume (160 mg/L) of flocs produced when 20 mg/L of PAC is used.

In the case where a ferric salt, such as ferric chloride, is used as an inorganic coagulant, the volume of iron hydroxide flocs may be slightly smaller than that of PAC. That is, the density (concentration) of iron hydroxide flocs may be slightly higher than that of PAC. In the case where ferric chloride is used, the amount of ferric chloride required is substantially equal to the amount of PAC required. Therefore, the impacts of the volume of flocs formed by the coagulant are as large as that of PAC.

On the other hand, although the estimated volume of flocs of MFRAC is not much different from that of PAC on a product basis as described above, when MFRAC is used, the use of MFRAC may reduce the amount of coagulate required for achieving the desired qualities and, consequently, the load placed on direct filtration.

<Filtration Treatment>

The coagulated water produced by the above coagulation treatment, in which MFRAC or the cationic organic coagulant and MFRAC are used, is filtered with a pressure or gravity filtration device or an MF or UF membrane module.

In the present invention, it is possible to perform filtration directly with the above filtration unit without performing solid-liquid separation using a sedimentation separation device or a floatation separation device prior to the filtration treatment. The filtrate is highly clear water, which may be used as RO membrane feedwater. The RO membrane treatment of the filtrate may produce high-quality desalted water.

### EXAMPLES

The present invention is described more specifically with reference to Test examples, Examples, and Comparative examples below.

<Industrial Water>

The following industrial water samples were subjected to a coagulation test.

Industrial water I: Mixture of industrial water produced in the Sakura water treatment plant and industrial water produced in the Inbanuma water treatment plant in Chiba, which were sampled on Oct. 27, 2015

Industrial water II: Mixture of industrial water produced in the Sakura water treatment plant and industrial water produced in the Inbanuma water treatment plant in Chiba, which were sampled on Aug. 18, 2015

Industrial water III: Industrial water produced in the Kashima water treatment plant in Ibaraki, which was sampled on Sep. 24, 2015

Table 2 summarizes the qualities of the industrial water samples.

The mixture of industrial water produced in the Sakura water treatment plant and industrial water produced in the Inbanuma water treatment plant was tested twice because the qualities of the mixed industrial water may vary with seasonal factors and the like.

TABLE 2

| | Industrial raw water | | | | | | | | |
|---|---|---|---|---|---|---|---|---|---|
| | | | Electric | Turbidity | Amount of P702 | No. 5A two-ply filtrate | | | |
| | pH | Alkalinity | conductivity | (degree: JIS | consumed | SFF | MFF | | Al |
| | (—) | (mg/L) | (mS/m) | method) | (ppm by PSD) | (—) | (—) | netNTU | (μg/L) |
| Industrial | 7.40 | 76.5 | 35.4 | 2.6 | 0.80 | 2.56 | 10.89 | 0.64 | 160 |
| water I | | | | | | | | | |
| Industrial | 7.46 | 84.7 | 30.9 | 1.8 | 0.51 | 1.45 | 2.06 | 0.41 | — |
| water II | | | | | | | | | |
| Industrial | 7.47 | 58.0 | 31.6 | 7.0 | 1.19 | 2.45 | 28.47 | 0.64 | — |
| water III | | | | | | | | | |

<Chemicals Used>

The following chemicals were used. Hereinafter, when the amount of chemical used is referred, the amount of the product added is described.

«Melamine-Formaldehyde Resin Acid Colloidal Solution (MFRAC)»

Agent for treating excess paint contained in water that circulates through an automotive paint booth, product name “Kuristuck B100”, produced by Kurita Water Industries Ltd.

Evaporation residue: 9.3% (coagulated solid content: 9% of the product), formaldehyde content: 3200 mg/kg, average colloidal particle size: 35 nm

(hereinafter, referred to as “MFRAC”)

«Cationic Organic Coagulant»

Poly-DADMAC: “Zeta Ace P702” produced by Kurita Water Industries Ltd.

Polymer content (evaporation residue): 92%, colloid equivalent: 5.89 meq/g (5.42 meq/g-product), intrinsic viscosity in 1 N solution of sodium nitrate: 0.75 dL/g

(hereinafter, referred to as “Zeta Ace P702” or “P702”)

Epichlorohydrin/dialkylamine condensation product: “Zeta Ace C350” produced by Kurita Water Industries Ltd.

Polymer content (evaporation residue): 51%, colloid equivalent: 6.80 meq/g (3.47 meq/g-product), intrinsic viscosity in 1 N solution of sodium nitrate: 0.13 dL/g

(hereinafter, referred to as “Zeta Ace C350” or “C350”)

Dicyandiamide/formaldehyde condensation product: “Kuriflock LC553” produced by Kurita Water Industries Ltd. (hereinafter, referred to as “Kuriflock LC553”)

Methyl glycol chitosan (MGCh): reagent for colloid titration produced by Wako Pure Chemical Industries, Ltd.

«Polyaluminum Chloride»

PAC: “PAC 250A” produced by TAKI CHEMICAL CO., LTD. (Al₂O₃: 10.2%)

<Evaluation Procedure>

Coagulation and filtration treatments were performed by the following procedure.

In the coagulation treatment, 500 mL of water sample was stirred at a high speed (150 rpm) for 6 minutes and subsequently at a low speed (50 rpm) for 6 minutes with a Jar Tester produced by Miyamoto Seisakusho.

In the coagulation treatment in which MFRAC and a cationic organic coagulant were used in combination, first, the water sample to which the cationic organic coagulant had been added was stirred at the high speed and, after a lapse of three minutes, MFRAC was added to the water sample.

In the filtration treatment, the whole amount of the coagulated water was filtered through a No. 5A two-ply filter paper sheet produced by Advantech Co., Ltd. (diameter: 185 mm). The microparticle-capturing effect of the filtration treatment stands midway between that of a two-layer gravity filtration device capable of filtering sand particles having a diameter of 0.45 mm and that of a two-layer pressure filtration device capable of filtering sand particles having a diameter of 0.60 mm.

<Measurement of SFF, MFF, and netNTU>

The measurement of SFF, MFF, and netNTU was conducted by the methods described in [MFF (Micro Filter Fouling Factor)] and [SFF (Soluble Polymer Fouling Factor)] above.

The MF (microfilter) used in the measurement was HAWP02500 produced by Merck Millipore.

The water sample was passed through the membrane at −67 kPa twice, that is, 150 mL of reference water and 150 mL of the water sample were passed through the membrane.

In the evaluations of SFF and MFF, whether an evaluation grade of 4 in the scale for evaluating the fouling of RO membrane described in Table 1 above was achieved or not was determined. Treated water evaluated as 4 or more on the scale was considered to have high clarity.

In the measurement of netNTU, 2100Q produced by HACH was used, and net value was calculated by subtracting the blank value (0.04 to 0.07) of ultrapure water from the measured value.

<Calculation of Amount of Solid Substance Generated by Coagulant>

The amount of solid substances generated by coagulation of each of the chemicals was calculated on the basis of the amount of evaporation residue, except for PAC.

P702: 92% of amount of chemical added (mg/L)

C350: 51% of amount of chemical added (mg/L)

MFRAC: 9.3% of amount of chemical added (mg/L)

Since solid substances generated by coagulation of PAC is Al(OH)3, 15.6% was used on the basis of the following calculation: 10.2(%)×2Al(OH)₃ (Mw: 156)/Al₂O₃ (Mw: 102).

<Calculation of Volumes of Coagulated Flocs of PAC and MFRAC (1)>

As described above, the volume of flocs prepared by centrifugal sedimentation of aluminum hydroxide formed by neutralizing 10000 mg/L of PAC was 8 times the volume of the PAC. The volume of flocs prepared by centrifugal sedimentation of precipitate formed by converting MFRAC into alkaline was 7 times the volume of the MFRAC.

The above ratios were used in the calculation of the reference volume of coagulated flocs in the treatment of industrial water.

<Calculation of Volumes of Coagulated Flocs of PAC and MFRAC (2)>

Since the volume of coagulated flocs of PAC was 8 times the volume of the PAC used, it is 8/0.156=51 times the volume of the solid component. In terms of density, 1/51×1000=19.6 (mg/kg). In terms of concentration, 1.96%.

Since the volume of coagulated flocs of MFRAC was 7 times the volume of the MFRAC used, it is 7/0.093=75 times the amount of the solid component, is 1/75×1000=13.3 (mg/kg) in terms of density, and is 1.33% in terms of concentration.

The above values are calculated taking only the coagulant into account. The density of the flocs of PAC was reduced (i.e., the volume of the flocs was increased) since a considerable amount of PAC was hydrated. Although the mechanism is not clear, it is considered that MFRAC also undergoes a reaction analogous to hydration similarly to PAC.

On the other hand, it is considered that the density of flocs formed of coagulant particles reacted with contaminant particles contained in the industrial water becomes higher (i.e., the volume of the flocs becomes smaller) than the density of the coagulant alone, because part of water of hydration detaches from the flocs.

<Assumption of Volume of Coagulated Flocs of Cationic Organic Coagulant>

Since the amount of cationic organic coagulant used is set to be 70 or less relative to 100 of the amount of cation consumed for changing the streaming potential of the industrial water to be zero, the whole amount of the cationic organic coagulant added to the industrial water reacts with the anionic colloidal substances contained in the industrial water and becomes insoluble. Accordingly, the degree of hydration is low.

On the other hand, anionic biopolymers, which are one of the anionic colloids with which the cationic organic coagulant reacts, form a polyion complex, which significantly reduces the degree of hydration.

This is similar to the phenomenon that occurs when a cationic dehydrating agent is used in the coagulation and dehydration of excess sludge produced in a biological treatment.

When excess sludge produced in a biological treatment is concentrated with a tabletop centrifugal separator at 3000 rpm for 5 minutes, the excess sludge has a concentration of about 5%. The concentration of the sludge is increased to about 10% when an adequate coagulation treatment is performed with a cationic organic coagulant.

The increase in the concentration (density) is caused as a result of the removal of water of hydration from mucilage (substance that can be dissolved and extracted with 0.1% NaOH) included in the excess sludge which is composed of biopolymer gel.

As described above, both an increase in the amount of water caused by the cationic organic coagulant and a reduction in the amount of water contained in the substance that reacts with the cationic organic coagulant may occur. Considering the above case of the dehydration of excess sludge, it is rational to consider that the absolute value of the reduction in the amount of water is larger.

Accordingly, it was assumed that the volume of coagulated flocs formed of the cationic organic coagulant be equal to the amount of solid component added.

### Test Example 1

MFRAC or PAC was added to the industrial water I in order to coagulate the industrial water I. The SFF and MFF of the No. 5A two-ply filtrate produced using the coagulated water were measured. FIG. 5 illustrates the relationships between the amounts of MFRAC and PAC added and the SFF of the filtrate. FIG. 6 illustrates the relationships between the amounts of MFRAC and PAC added and the MFF of the filtrate. In FIGS. 5 and 6, the amount of chemical added is on a product basis. In FIGS. 5 and 6, the dotted and broken lines denote the border between grades of 4 and 5 in the scale described in Table 1.

The netNTU (turbidity) and ultraviolet absorbance of the No. 5A two-ply filtrate at 260 nm was measured using a 50-mm cell. FIG. 7 illustrates the relationships between the amounts of chemicals used and the netNTU (turbidity) of the filtrate. FIG. 8 illustrates the relationships between the amounts of chemicals used and the ultraviolet absorbance of the filtrate.

The results illustrated in FIGS. 5 and 6 confirm the following facts.

The amount of MFRAC (product) with which the SFF of the filtrate was evaluated as 5 or more on the scales for evaluating the fouling of membrane by RO membrane feedwater which are described in Table 1 was 8 mg/L (the point of intersection of the dotted line and the curve). The amount of MFRAC (product) with which the MFF of the filtrate was evaluated as 5 or more on the evaluation scales was 10 mg/L.

On the other hand, when PAC was used, the amount of PAC with which the SFF of the filtrate was evaluated as 5 or more on the evaluation scales was about 100 mg/L. The amount of PAC with which the MFF of the filtrate was evaluated as 5 or more on the evaluation scales was about 130 mg/L, which is about 13 times the amount of MFRAC required.

MFRAC was capable of producing greater advantageous effects than PAC particularly in terms of SFF.

The amounts of solid substances generated by the coagulants are PAC: 15.6% and MFRAC: 9% of the amount of the products used. The estimated volumes of flocs generated by PAC and MFRAC are 8 times and 7 times, respectively, the amounts of the coagulants used. That is, the estimated volume of flocs generated by MFRAC is smaller than that generated by PAC.

Accordingly, it is possible to reduce the filtering load resulting from the coagulant that has been used for coagulation by 1/15.

The absolute effects of MFRAC was significant particularly in terms of SFF. This is presumably because neutral polysaccharides included in the biopolymers which have no carboxyl group or a trace amount of carboxyl group, which is difficult to coagulate with an inorganic coagulant, such as PAC, were coagulated and removed by MFRAC.

The results illustrated in FIGS. 7 and 8 confirm that MFRAC has advantageous effects comparable to those of PAC on a product basis in terms of netNTU (turbidity) and ultraviolet absorbance.

### Test Example 2

MFRAC or PAC was added to the industrial water II in order to coagulate the industrial water II. The SFF and MFF of the No. 5A two-ply filtrate produced using the coagulated water were measured. FIG. 9 illustrates the relationships between the amounts of MFRAC and PAC added and the SFF of the filtrate. FIG. 10 illustrates the relationships between the amounts of MFRAC and PAC added and the MFF of the filtrate. In FIGS. 9 and 10, the amount of chemical added is on a product basis.

The results illustrated in FIGS. 9 and 10 confirm the following facts.

The SFF and MFF of the filtrate were reduced to the level that corresponds to a grade of 5 or more (SFF: 1.04<, MFF: 1.06<) on the scales for evaluating the fouling of membrane by RO membrane feedwater which are described in Table 1 when the amount of MFRAC (product) added was 7 to 8 mg/L.

In contrast, in the case where PAC was used, it was necessary to use 120 mg/L or more of PAC, and the amount of product added was 16 times the amount of MFRAC required.

Therefore, in the treatment of the industrial water II, it was possible to reduce the filtering load due to the coagulant that has been used in coagulation to be less than 1/15 of the filtering load of the industrial water I.

### Test Example 3

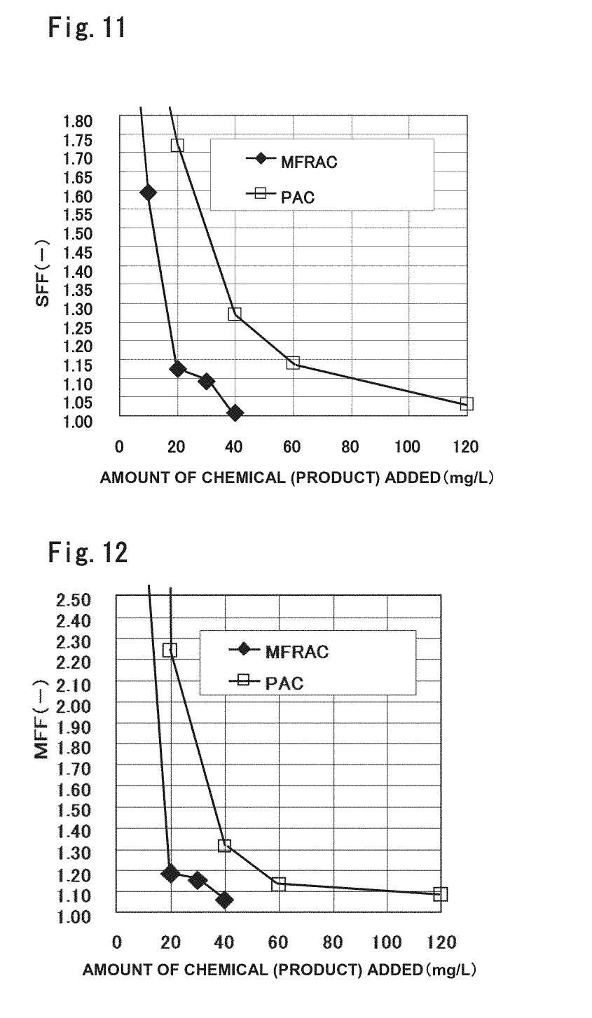

MFRAC or PAC was added to the industrial water III in order to coagulate the industrial water III. The SFF and MFF of the No. 5A two-ply filtrate produced using the coagulated water were measured. FIG. 11 illustrates the relationships between the amounts of MFRAC and PAC added and the SFF of the filtrate. FIG. 12 illustrates the relationships between the amounts of MFRAC and PAC added and the MFF of the filtrate. In FIGS. 11 and 12, the amount of chemical added is on a product basis.

The results illustrated in FIGS. 11 and 12 confirm the following facts.

The SFF and MFF of the filtrate were reduced to the level that corresponds to a grade of 5 or more (SFF: 1.04<, MFF: 1.06<) on the scales for evaluating the fouling of membrane by RO membrane feedwater which are described in Table 1 when the amount of MFRAC (product) added was 35 to 40 mg/L.

On the other hand, in the case where PAC was used, it was necessary to use about 120 mg/L of PAC. Although the amount of PAC required was substantially equal to the amounts of PAC required in the treatment of the industrial water I or II, the amount of MFRAC required was increased to 4 to 5 times the amounts of MFRAC required in the treatment of the industrial water I or II.

Note that, even in this case, the amount of chemical product used was ⅓ or less of the amount of PAC used.

The first reason for which the amount of MFRAC added was large is presumably that the amount of cation included in the cationic organic coagulant (P702) consumed, which was measured by a streaming potential method, was 1.19 mg/L, which is larger than 0.80 mg/L in the treatment of the industrial water I or 0.51 mg/L in the treatment of the industrial water II, and the MFRAC was consumed accordingly.

### Test Example 4

FIG. 13 illustrates the results of measurement of the amount of MFRAC added to the industrial water II at which the streaming potential determined by a streaming potential method was zero by titration using a PCD.

As illustrated in FIG. 13, the amount of MFRAC used at which the potential was zero was 128 mg/L. On the other hand, the amount of MFRAC required for achieving Grade 4 or higher of the evaluation scale described in Table 1 above was only about 8 mg/L as illustrated in FIGS. 9 and 10. It is considered that the streaming charge is certainly negative when MFRAC is used in such an amount.

However, in the case where the amount of charge of the anion colloid contained in the industrial water is large, the amount of MFRAC required for the treatment is increased as a result of consumption by the anionic colloidal substances. Specifically, as illustrated in FIGS. 11 and 12, the amount of MFRAC required by the industrial water III for achieving Grade 4 or higher was 40 mg/L.

Therefore, it is preferable to use a cationic organic coagulant in combination with MFRAC in order to consume part of charge of the anionic colloid and reduce the amount of MFRAC required by the treatment.

### Test Example 5

The amount of Zeta Ace P702 consumed by the industrial water I determined with a PCD was 0.80 mg/L (0.80×5.42=4.3 μeq/L).

FIG. 14 illustrates the results of the measurement of SFFs and MFFs of the No. 5A two-ply filtrates each produced from the industrial water I coagulated by adding 7 mg/L of MFRAC and a specific amount of Zeta Ace P702 to the industrial water I.

The results illustrated in FIG. 14 confirm that, in the case where Zeta Ace P702 is used in combination of MFRAC, the amount of P702 used is suitably 0.1 to 0.6 mg/L, which is considerably smaller than the amount of P702 required for changing the streaming charge determined with a PCD to be zero, that is, 0.8 mg/L. The closer to 0.8 mg/L (the amount of P702 required for changing the streaming charge to be zero) the amount of P702 used, the higher (i.e., worse) the SFF and MFF of the filtrate.

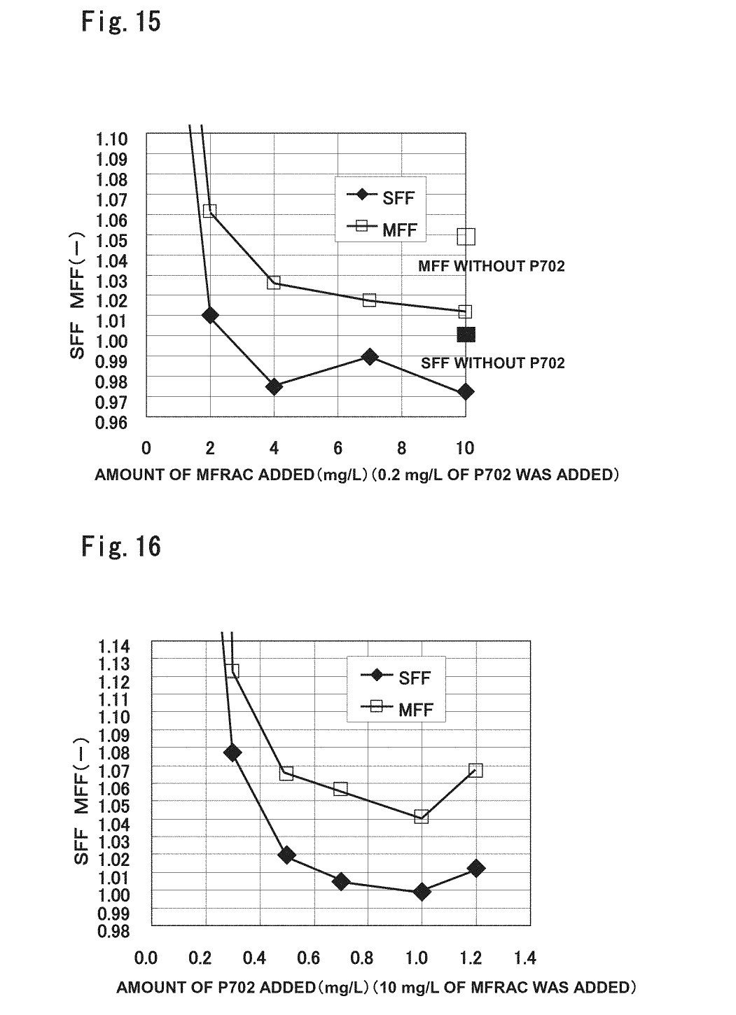

Since it was confirmed from the results illustrated in FIG. 14 that it is effective to set the amount of Zeta Ace P702 used to be about 0.2 mg/L, the SFFs and MFFs of the No. 5A two-ply filtrates each produced from the water coagulated by adding a specific amount of MFRAC and 0.2 mg/L of P702 to the industrial water were measured. FIG. 15 illustrates the results.

As illustrated in FIG. 15, advantageous effects comparable to those achieved when 10 mg/L of MFRAC is used without using Zeta Ace P702 were achieved by adding about 3 mg/L of MFRAC in combination with 0.2 mg/L of P702.

### Test Example 6

The amount of Zeta Ace P702 consumed by the industrial water III determined with a PCD was 1.19 mg/L (1.20×5.42=6.5 μeq/L).

FIG. 16 illustrates the results of the measurement of SFFs and MFFs of the No. 5A two-ply filtrates each produced from the industrial water III coagulated by adding 10 mg/L of MFRAC and a specific amount of Zeta Ace P702 to the industrial water III.

The results illustrated in FIG. 16 confirm that, in the case where Zeta Ace P702 is used in combination of MFRAC, the amount of P702 used is suitably 0.5 to 1.0 mg/L, which is considerably smaller than the amount of P702 required for changing the streaming charge determined with a PCD to be zero, that is, 1.19 mg/L.

As in the case for the industrial water I, the closer to 1.2 mg/L (the amount of P702 required for changing the streaming charge to be zero) the amount of P702 used, the higher (worse) the SFF and MFF of the filtrate.

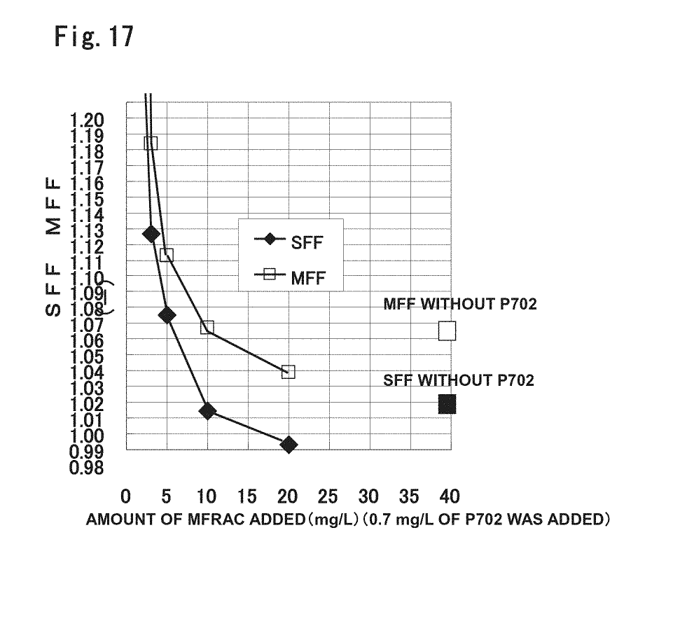

Since it was confirmed from the results illustrated in FIG. 16 that it is effective to set the amount of Zeta Ace P702 used to be about 0.7 mg/L, the SFFs and MFFs of the No. 5A two-ply filtrates each produced from the water coagulated by adding a specific amount of MFRAC and 0.7 mg/L of P702 to the industrial water were measured. FIG. 17 illustrates the results.

As illustrated in FIG. 17, advantageous effects comparable to those achieved when 40 mg/L of MFRAC is used without using Zeta Ace P702 were achieved by adding about 10 mg/L of MFRAC in combination with 0.7 mg/L of P702.

The results obtained in Test Examples 5 and 6 prove the following facts on the appropriate amounts of chemical added to the industrial water samples I and III when P702 was used in combination. Adding the chemical in an amount equal to the amount of P702 consumed by the industrial water, that is, with which the streaming charge determined by a streaming potential method (PCD) becomes zero, unfavorably increases the SFF and MFF of the filtrate.

It is adequate to add the chemical to the industrial water I in an amount equal to about 15% (0.12 mg/L) to about 75% (0.6 mg/L) of the amount of P702 consumed by the industrial water I, that is, 0.8 mg/L. It is adequate to add the chemical to the industrial water III in an amount equal to about 40% (0.5 mg/L) to about 85% (1.0 mg/L) of the amount of P702 consumed by the industrial water III.

Even when the cationic organic coagulant was not used and MFRAC was used alone, A grade of 4 or more in the scale for evaluating RO membrane feedwater described in Table 1 was achieved by increasing the amount of MFRAC used. Furthermore, using the cationic organic coagulant in an amount larger than the amount of cationic organic coagulant consumed by the water may cause fouling particularly in UF membrane filtration, MF membrane filtration, and RO membrane treatment of the filtrate. Therefore, it is adequate to set the maximum amount of cationic organic coagulant used to be 70% or less of the amount of cationic organic coagulant consumed by the water.

The minimum amount of cationic organic coagulant used is not specified (0%), because sufficient advantageous effects are achieved by using only the primary coagulant, that is, MFRAC. It is preferable to set the amount of cationic organic coagulant used in combination with MFRAC to be 20 to 50% of the amount of cationic organic coagulant consumed by the water.

### Test Example 7

The specific one of cationic organic coagulants having different structures was added to organic wastewater treated by biological treatment and precipitation, which contain a larger amount of anionic colloid than industrial water and are easy to evaluate using charge neutralization. The amount of cation consumed by the treated water was determined with a PCD.

The amount of coagulant consumed was multiplied with the colloid equivalent of the product including the coagulant and converted into μeq/L unit. The difference in efficiency between the structures was evaluated relative to 100 of the amount of poly-DADMAC consumed.

Table 3 summarizes the results.

A score lower than 100 indicates that the cationic groups of the chemical worked more effectively than those of poly-DADMAC. A score higher than 100 indicates that the cationic groups of the chemical did not work effectively.

The efficiency of cationic groups of methyl glycol chitosan (MGCh), which is used as a reagent for colloid titration, was the highest.

Cationic groups of poly-DADMAC had the second highest efficiency. When condensed cation such as an epichlorohydrin/dialkylamine condensation product and a dicyandiamide/formaldehyde condensation product were used, the amount of cation used was about twice the amount of poly-DADMAC.

The cationic groups of MGCh locate the respective outermost ends of the polymer chain and are distant from each other. Furthermore, since the polymer chain has a rigid structure, the cationic groups are always exposed to the outside. This presumably enables all the cationic groups to react with the anionic colloids contained in the liquid that is to be treated and results in the high efficiency.

In contrast, the cationic groups included in the condensation-based coagulants locate inside the polymer backbone and are close to each other. Furthermore, the cationic groups are not likely to be exposed to the outside. This results in production of unreacted, excess cationic groups and degrades the efficiency.

On the other hand, the cationic groups of Poly-DADMAC locate at the respective ends of the polymer side chains, which are relatively large. This presumably enables the cationic groups to work in a relatively effective manner.

TABLE 3

| | | | | Colloid | | Amount of | | |
|---|---|---|---|---|---|---|---|---|
| | | | | equivalent | | substance | Amount of | Amount of |
| | | | | per active | Colloid | consumed, | cationic | cation |
| | | | Amount of | component | equivalent of | determine by | colloid | consumed, |
| | | Position of | active | (meq/g-net | product | PCD titration | consumed | relative to |
| Substance | Name of Item | cation | component | content) | (meq/g) | (mg/L) | (μeq/L) | 100 of P702 |
| Methyl glycol | Reagent for colloid | Outside large | 1/200 | — | — | — | 28.0 | 65 |
| chitosan(MGCh) | titration (Wako Pure | pyranose | Normality | | | | | |
| | Chemical Industries, | skeleton | | | | | | |
| | Ltd.) | | | | | | | |
| poly-DADMAC | Zeta Ace P702 | Side chain | 92% | 5.9 | 5.43 | 8.0 | 43.4 | 100 |
| | (Kurita Water | (pendant) | | | | | | |
| | Industries Ltd.) | | | | | | | |
| Epichlorohydrin/ | Zeta Ace P305 | Inside | 50% | 6.8 | 3.40 | 24.0 | 81.6 | 188 |
| dialkylamine | (Kurita Water | backbone | | | | | | |
| condensation | Industries Ltd.) | | | | | | | |
| product | | | | | | | | |
| Dicyandiamide/ | Kuriflock LC553 | Inside | 50% | 4.8 | 2.40 | 52.0 | 124.8 | 288 |
| formaldehyde | (Kurita Water | backbone | | | | | | |
| condensation | Industries Ltd.) | | | | | | | |
| product | | | | | | | | |

### Test Example 8

Whether MFRAC contaminates industrial water in the case where MFRAC is added to industrial water that is markedly clear without treatment was determined using tap water.

The tap water used was the city water of Nogi-machi, Tochigi, which is, as described below, highly clear water evaluated as 5 to S on the scale for evaluating the fouling of membrane by RO membrane feedwater described in Table 1. The amount of anionic colloid included in the water was markedly small.

«Qualities of City Water of Nogi-Machi, Tochigi»

SFF: 0.975

MFF: 1.003

pH: 6.84

Alkalinity: 25.3 mg/L

Amount of charge of colloid by MGCh: 0.01 μeq/L (amount of chemical consumed in terms of poly-DAMAC (P702): 0.02 mg/L)

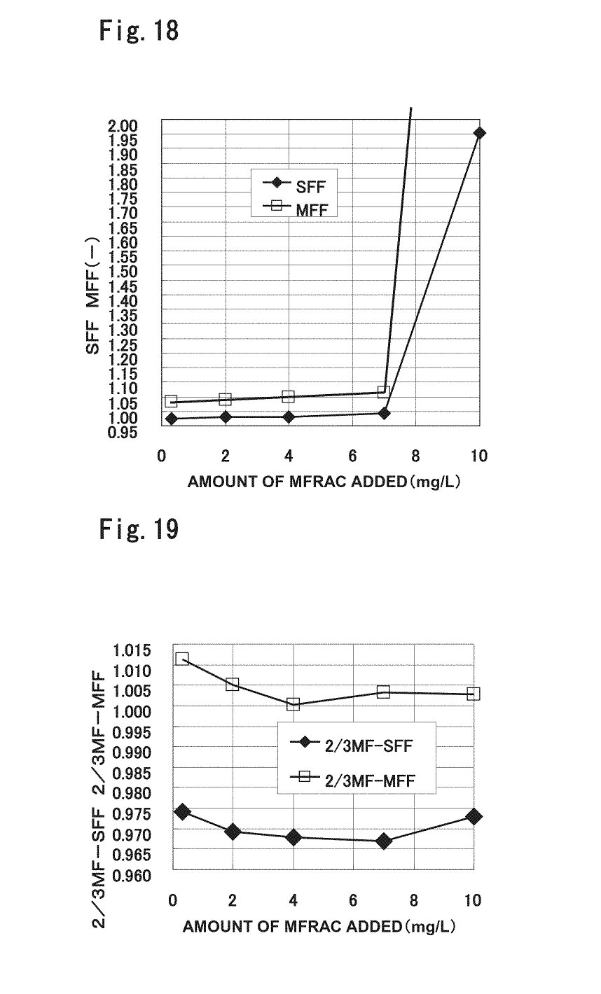

FIG. 18 illustrates the relationships between the SFF and MFF of the No. 5A two-ply filtrate produced from coagulated water prepared by adding MFRAC to the city water of Nogi-machi, Tochigi and the amount of MFRAC added.

The SFF and MFF of the filtrate slightly increased (degraded) when the amount of MFRAC added was 4 mg/L or less and significantly degraded when the amount of MFRAC added was 10 mg/L.

FIG. 19 illustrates the results of measurement of the relationships between the amount of MFRAC added and the SFF and MFF of the No. 5A two-ply filtrate produced from coagulated water prepared by adding MFRAC to the filtrate prepared by filtering the city water of Nogi-machi, Tochigi through an MF membrane having a maximum pore size of 0.45 μm. As illustrated in FIG. 19, the contamination due to the leakage of MFRAC did not occur. In FIG. 19, “⅔MF” means that all the permeate samples used for measuring SFF and MFF were diluted to ⅔ with 1 part of reference water.

The above results confirm the following facts.

(1) In the case where the amount of MFRAC used is small, adding MFRAC to markedly clean water causes formation of aggregates because even the clean water contains the substances capable of reacting with MFRAC. The aggregates can be filtered off by the No. 5A two-ply filtration (capable of capturing microparticles having a size of about 1 μm or more).

(2) In the case where the amount of MFRAC added is large, only the MFRAC particles are coagulated to form aggregates that are microparticles having a size of 1 μm or less. Part of the microparticles may pass through the No. 5A two-ply filter and leak into the filtrate.

(3) The leaked substances described in (2) have a particle size of 0.5 to 1 μm since they can be captured through an MF membrane having a maximum pore size of 0.45 μm.

(4) Since the size of colloidal particles of MFRAC is several tens of nanometers (0.02 to 0.05 μm), the particles passed through the No. 5A two-ply filter are expanded to a size about 20 times the original size.

### Test Example 9

The reaction pH was increased in order to promote the self-coagulation of MFRAC.

Specifically, the pH of the city water of Nogi-machi, Tochigi, was increased to 7 or more by one of the methods (i), (ii), and (iii) below. Subsequently, 10 mg/L of MFRAC was added to the city water in order to coagulate the water. The SFF and MFF of No. 5A two-ply filtrate produced using the coagulated water were measured.

(i) Adjusted to pH: 7.5 by adding NaOH

(ii) Adjusted to pH: 7.34 by aerating the water for 10 minutes

(iii) Adjusted to pH: 7.14 by exposing the liquid surface for 20 hours

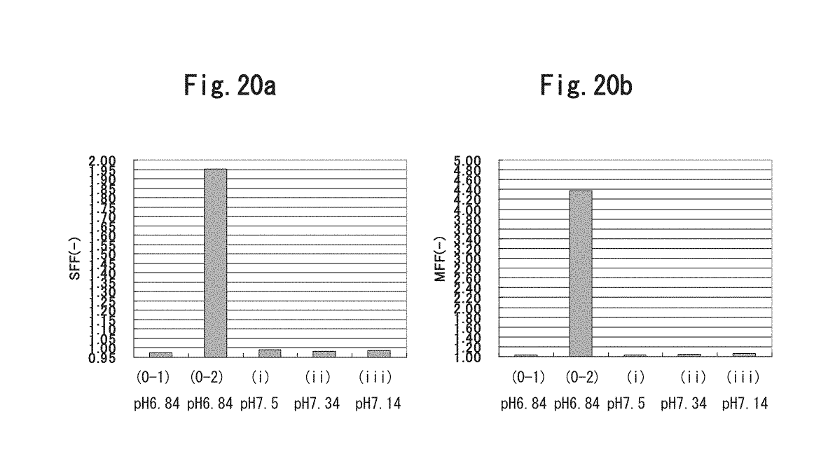

FIGS. 20a and 20b illustrate the results.

In FIGS. 20a and 20b, “(0-1)” (pH: 6.84) and “(0-2)” (pH: 6.84) are results of the measurement of the city water of Nogi-machi, Tochigi, the pH of which had not been increased, where (0-1) denotes the result obtained when MFRAC was not added to the water and (0-2) denotes the result obtained when MFRAC was added to the water.

The results illustrated in FIGS. 20a and 20b confirm that adjusting the pH of the water that is to be coagulated to be 7 or more promotes the self-coagulation of MFRAC and, consequently, reduces contamination caused by the addition of MFRAC.

### Coagulation and Filtration of Industrial Water I (Examples 1 to 10 and Comparative Examples 1 to 8)

The specific one of the chemicals described in Table 4 was added to the industrial water I in the specific amount described in Table 4. The industrial water was coagulated by the above-described method and then subjected to the No. 5A two-ply filtration. Table 4 summarizes the results of the evaluations made in the above treatment.

TABLE 4

| | Cationic organic coagulant | | | | | | | | | | | | |
|---|---|---|---|---|---|---|---|---|---|---|---|---|---|
| | | | Proportion | | | | | | | | | Amount | |
| | | | to amount | | | | Evaluations of qualities of | | | | | of solid | |
| | | | of cation | | | | No. 5A two-ply filtrate | | | | | component | Esti- |
| | | Amount of | consumed | Amount | Amount | | | | Grade on | | | generated | mated |
| Comparative | | coagulant | (by PCD | of MFRAC | of PAC | Coagula- | | | scale de- | | | from | volume |
| example/ | | added | ratio) | added | added | tion pH | | | scribed in | | Al | coagulant | of flocs |
| example | Type | (ppm) | (%) | (ppm) | (ppm) | (—) | SFF | MFF | Table 1 | netNTU | (μg/L) | (mg/L) | (μL/L) |
| Comparative | — | — | — | — | 0 | 7.4 | 2.56 | 1.089 | 0 | 0.64 | 160 | 0 | 0 |
| example 1 | | | | | | | | | | | | | |
| Comparative | — | — | — | — | 20 | 7.2 | 1.35 | 1.39 | 1 | 0.07 | 200 | 3.1 | 160 |
| example 2 | | | | | | | | | | | | | |
| Comparative | — | — | — | — | 40 | 7.0 | 1.18 | 1.27 | 2 | 0.03 | 143 | 6.2 | 320 |
| example 3 | | | | | | | | | | | | | |
| Comparative | — | — | — | — | 60 | 6.9 | 1.118 | 1.16 | 3 | 0.02 | 113 | 9.4 | 480 |
| example 4 | | | | | | | | | | | | | |
| Comparative | — | — | — | — | 100 | 6.8 | 1.032 | 1.093 | 4 | 0.01 | 81 | 15.6 | 800 |
| example 5 | | | | | | | | | | | | | |
| Comparative | — | — | — | — | 150 | 6.7 | 1.006 | 1.039 | 5 | 0.01 | 50 | 23.4 | 1200 |
| example 6 | | | | | | | | | | | | | |
| Example 1 | — | — | — | 7 | — | 7.4 | 1.038 | 1.097 | 4 | 0.06 | 77 | 0.7 | 49 |
| Example 2 | — | — | — | 10 | — | 7.4 | 1.003 | 1.058 | 5 | 0.02 | 86 | 0.9 | 70 |
| Example 3 | — | — | — | 15 | — | 7.4 | 0.995 | 1.024 | S | 0.01 | 80 | 1.4 | 105 |
| Comparative | P703 | 0.2 | 25 | 0 | — | 7.4 | 1.30 | 1.37 | 1 | 0.07 | | 0.2 | 0.2 |
| example 7 | | | | | | | | | | | | | |
| Comparative | P702 | 0.6 | 25 | 0 | — | 7.4 | 1.019 | 1.080 | 4~5 | 0.03 | | 0.6 | 0.6 |
| example 8 | | | | | | | | | | | | | |
| Example 4 | P702 | 0.2 | 25 | 4 | — | 7.4 | 0.990 | 1.026 | S | 0.02 | | 0.6 | 28 |
| Example 5 | P702 | 0.2 | 25 | 7 | — | 7.4 | 0.986 | 1.018 | S | 0.02 | 75 | 0.8 | 49 |
| Example 6 | P702 | 0.2 | 25 | 10 | — | 7.4 | 0.972 | 1.011 | S | 0.02 | | 1.1 | 70 |
| Example 7 | P702 | 0.1 | 13 | 7 | — | 7.4 | 0.990 | 1.009 | S | 0.02 | | 0.7 | 49 |
| Example 8 | P702 | 0.4 | 50 | 7 | — | 7.4 | 0.984 | 1.017 | S | 0.02 | 79 | 1.0 | 49 |
| Comparative | P702 | 0.8 | 100 | 7 | — | 7.4 | 1.014 | 1.079 | 4~5 | 0.03 | 75 | 1.4 | 50 |
| example 9 | | | | | | | | | | | | | |
| Example 9 | C350 | 0.8 | 26 | 4 | — | 7.4 | 1.002 | 1.035 | 5 | 0.02 | | 0.8 | 28 |
| Example 10 | C350 | 1.6 | 52 | 4 | — | 7.4 | 0.987 | 1.013 | S | 0.02 | | 1.2 | 29 |

The results described in Table 4 confirm the following facts.

The results obtained in Examples 1 to 3 confirm that the clarity that satisfies a grade of 4 or more on the evaluation scale described in Table 1 can be achieved by adding 7 mg/L or more of MFRAC and performing the No. 5A two-ply filtration. The increases in the amount of solid substances which were caused by the coagulant were 0.7 to 1.4 mg/L, which are half or less the amount of solid substances generated when 20 mg/L of PAC was used, that is, 3.1 mg/L, and are the amounts at which the filtrate can be directly filtered without performing primary solid-liquid separation. The estimated volumes of flocs were 50 to 100 μL/L, which are smaller than the estimated amount of flocs generated when 20 mg/L of PAC is added, that is, 160 μg/L.

In Comparative example 2, where the amount of PAC added to the industrial water was 20 mg/L, at which the industrial water can be directly filtered, a grade of 1 on the evaluation scale described in Table 1 was given.

The Al concentrations in the filtrates prepared by coagulation and No. 5A two-ply filtration in Examples 1 to 3 were reduced to around 80 μg/L from the 160 μg/L, which is the Al concentration in the filtrate prepared in Comparative example 1, where no chemical was added. The Al concentration in the filtrate prepared in Comparative example 2, where 20 mg/L of PAC was used, was 200 μg/L, which is higher than that of the filtrate prepared in the case where no chemical was used.

In the case where the amount of PAC added to the industrial water was 20 mg/L, at which the resulting aggregate can be directly filtered, the netNTU (turbidity) of the filtrate was 0.07, that is, less than 0.1, and the filtrate was visually transparent. However, the filtrate was considerably inadequate as RO membrane feedwater (Comparative example 2).

In the cases where the amount of PAC added to the industrial water was 40 to 60 mg/L, which is normally employed in a facility where primary solid-liquid separation is performed, a grade of 4 on the evaluation scale described in Table 1 was not achieved (Comparative examples 3 and 4). In addition, the amount of remaining Al was large compared with the cases where MFRAC was used.

In Comparative example 5, where the amount of PAC added to the industrial water was 100 mg/L, a grade of 4 on the evaluation scale described in Table 1 was achieved and the amount of remaining Al was 80 μg/L. However, the amount of solid substances generated by the coagulant was 15.6 mg/L, which was 20 times the amount of solid substances generated when the amount of MFRAC added was 7 mg/L. This increased the chemical costs and the costs for disposal of sludge.

In Comparative example 6, where 150 mg/L of PAC was used, the amount of Al that remained in the No. 5A two-ply filtrate was small compared with the cases where MFRAC was used and a grade of 5 on the evaluation scale described in Table 1 was achieved. However, it was not possible to achieve a grade of S and, naturally, the amount of solid substances generated by PAC was 40 to 30 times the amount of solid substances generated in the recommended case where P702 (0.2 mg/L) and MFRAC (4 to 7 mg/L) are used in combination.

In the cases where 0.2 mg/L of cationic organic coagulant, which is equal to 25% of the amount of cation included in the cationic organic coagulant consumed by the industrial water I, which is measured by a streaming potential method, that is, 0.8 mg/L, was used in combination with MFRAC, the No. 5A two-ply filtrate was evaluated as S, that is, the highest grade, when the amount of MFRAC added was 4 mg/L. The highest grade of S was given and the advantageous effects were not impaired even in the case where the amount of MFRAC was increased to 7 or 10 mg/L (Examples 4 to 6).

In Comparative example 7, where 0.2 mg/L of P702 was added to the industrial water but MFRAC was not used, a low evaluation grade of 1 was given.

In the case where the amount of P702 added was increased to 0.6 mg/L, which is equal to 75% of the amount of cation consumed, the self-coagulation effect of cation was increased and, consequently, an evaluation grade of 4 to 5 was achieved. However, there was a high risk of the streaming charge becoming around zero and the SFF and MFF of the No. 5A two-ply filtrate becoming degraded even when the qualities of the industrial water varied slightly (Comparative example 8).

In all the cases where 7 mg/L of MFRAC was added to the industrial water and the amount of P702 added was changed from 0.1 mg/L (13%) to 0.4 mg/L (50%) relative to the amount of cation consumed, that is, 0.8 mg/L (Examples 5, 7, and 8), an evaluation grade of S was given to the No. 5A two-ply filtrate and an evaluation grade of S, which is two-rank higher than the evaluation grade (4) given to Example 1 where P702 was not used, was given.

The above results confirm that the recommended amount of P702 added to the industrial water I is 15% to 50% of the amount of cation of P702 consumed.

In the cases where 4 mg/L of MFRAC was added to the industrial water, an evaluation grade of 5 was achieved when the epichlorohydrin/dialkylamine condensation product (C350) was used in combination in an amount equal to 26% of the amount of cation consumed and an evaluation grade of S was achieved when C350 was used in combination in an amount equal to 52% of the amount of cation consumed (Examples 9 and 10). The advantageous effects achieved in Example 9 were comparable to those achieved in Example 4, where 0.2 mg/L (25%) of P702 and 4 mg/L of MFRAC were used in combination.

However, while the net amount of P702 used was 0.2 mg/L×0.92=0.18 mg/L, the net amount of C350 used was 0.8 mg/L×0.51=0.41 mg/L, which is twice or more the net amount of P702.

### Coagulation and Filtration of Industrial Water II (Examples 11 to 16 and Comparative Examples 9 to 15)

The specific one of the chemicals described in Table 5 was added to the industrial water II in the specific amount described in Table 5. The industrial water was coagulated by the above-described method and then subjected to the No. 5A two-ply filtration. Table 5 summarizes the results of the evaluations made in the above treatment.

TABLE 5

| | Cationic organic coagulant | | | | | | | | | | | |
|---|---|---|---|---|---|---|---|---|---|---|---|---|
| | | | Proportion | | | | | | | | Amount of | |
| | | | to amount | | | | Evaluations of qualities of | | | | solid | |
| | | | of cation | | | | No. 5A two-ply filtrate | | | | component | Esti- |
| | | Amount of | consumed | Amount | Amount | | | | Grade on | | generated | mated |
| Comparative | | coagulant | (by PCD | of MFRAC | of PAC | Coagula- | | | scale de- | | from | volume |
| example/ | | added | ratio) | added | added | tion pH | | | scribed in | | coagulant | of flocs |
| example | Type | (ppm) | (%) | (ppm) | (ppm) | (—) | SFF | MFF | Table 1 | netNTU | (mg/L) | (μL/L) |
| Comparative | — | — | — | — | 0 | 7.5 | 1.45 | 2.06 | 1 | 0.41 | 0 | 0 |
| example 9 | | | | | | | | | | | | |
| Comparative | — | — | — | — | 20 | 7.3 | 1.27 | 1.78 | 1 | 0.07 | 3.1 | 160 |
| Example 10 | | | | | | | | | | | | |
| Comparative | — | — | — | — | 40 | 7.1 | 1.13 | 1.23 | 2 | 0.06 | 6.2 | 320 |
| example 11 | | | | | | | | | | | | |
| Comparative | — | — | — | — | 80 | 6.9 | 1.063 | 1.13 | 3~4 | 0.04 | 12.5 | 640 |
| example 12 | | | | | | | | | | | | |
| Comparative | — | — | — | — | 120 | 6.8 | 1.039 | 1.081 | 4 | 0.01 | 18.7 | 960 |
| example 13 | | | | | | | | | | | | |
| Example11 | — | — | — | 8 | — | 7.5 | 0.999 | 1.070 | 5 | 0.04 | 0.7 | 56 |
| Comparative | P702 | 0.2 | 39 | 0 | — | 7.5 | 1.20 | 1.52 | 1~2 | 0.07 | 0.2 | 0.2 |
| example 14 | | | | | | | | | | | | |
| Example12 | P702 | 0.2 | 39 | 2 | — | 7.5 | 1.020 | 1.078 | 4~5 | 0.06 | 0.4 | 14 |
| Example13 | P702 | 0.2 | 39 | 4 | — | 7.5 | 0.986 | 1.037 | 5~S | 0.03 | 0.6 | 28 |
| Example14 | P702 | 0.2 | 39 | 8 | — | 7.5 | 0.988 | 1.021 | S | 0.03 | 0.9 | 56 |
| Example15 | P702 | 0.12 | 24 | 4 | — | 7.5 | 0.998 | 1.044 | S | 0.03 | 0.5 | 28 |
| Example16 | P702 | 0.3 | 59 | 4 | — | 7.5 | 0.988 | 1.033 | 5~S | 0.03 | 0.6 | 28 |
| Comparative | P702 | 0.8 | 157 | 4 | — | 7.5 | 1.038 | 1.125 | 4 | 0.03 | 1.1 | 29 |
| Example 15 | | | | | | | | | | | | |

The results described in Table 5 confirm the following facts.

The filtrate produced by adding 8 mg/L of MFRAC to the industrial water II and subsequently performing the No. 5A two-ply filtration had the clarity graded as 5 on the evaluation scale described in Table 1 (Example 11).

The increase in the amount of solid substances caused by the coagulant was 0.7 mg/L, which is ¼ or less of the amount (3.1 mg/L) of solid substances generated in the case where 20 mg/L of PAC was added to the industrial water (Comparative example 10) and is small enough to directly filtering the water without performing primary solid-liquid separation.

In the cases where no chemical was added to the industrial water, the SFF of the filtrate produced using the industrial water II was 1.45 while the SFF of the filtrate produced using the industrial water I was 2.56 and the MFF of the filtrate produced using the industrial water II was 2.06 while the MFF of the filtrate produced using the industrial water I was 10.89. This confirms that the degree of contamination of the industrial raw water was small (Comparative examples 1 and 9).

However, the SFF of the filtrate produced in the case where 40 mg/L of PAC was added to the industrial water II was 1.13 while the SFF of the filtrate produced in the case where 40 mg/L of PAC was added to the industrial water I was 1.18. The MFF of the filtrate produced in the case where 40 mg/L of PAC was added to the industrial water II was 1.23 while the MFF of the filtrate produced in the case where 40 mg/L of PAC was added to the industrial water I was 1.27. The filtrate was graded as 2 on the evaluation scale described in Table 1. That is, the effects of treatment using PAC were unfavorable. An evaluation grade of 4 was finally given when the amount of PAC added was increased to 120 mg/L (Comparative examples 11 to 13).

In the cases where 0.2 mg/L of P702, which is equal to 39% of the amount of cation consumed, was used in combination and the amount of MFRAC added to the industrial water was increased to 2 mg/L (Example 12), 4 mg/L (Example 13), and 8 mg/L (Example 14), the evaluation grade in Table 4 given to the filtrate was increased from 4 to 5 to 5 and from S to S. In Comparative example 14, where MFRAC was not added to the industrial water, an evaluation grade of 1 to 2 was given. This confirms that it is essential to use MFRAC.

In the cases where 4 mg/L of MFRAC was added to the industrial water and the amount of P702 added was set to 24% (0.12 mg/L), 39% (0.2 mg/L), 59% (0.3 mg/L), and 157% (0.8 mg/L) of the amount of cation consumed, evaluation grades of 5, 5 to S, 5 to S, and 4, respectively, described in Table 1 were given (Examples 15, 13, and 16 and Comparative example 15).

Since all the indices were good and did not vary widely in the range of 24% to 59%, it is considered appropriate to add P702 to the industrial water in an amount equal to 20% to 50% of the amount of cation consumed. However, in the case where the industrial water II is to be treated, sufficient effects graded as 5 may be achieved by adding 8 mg/L of MFRAC even when P702 is not used.

On the other hand, as in Comparative example 15, adding P702 to the industrial water in an amount that exceeds the amount of cation consumed (0.51 mg/L) clearly degrades the qualities of the No. 5A two-ply filtrate.

### Coagulation and Filtration of Industrial Water III (Examples 17 to 20 and Comparative Examples 16 to 21)

The specific one of the chemicals described in Table 6 was added to the industrial water III in the specific amount described in Table 6. The industrial water was coagulated by the above-described method and then subjected to the No. 5A two-ply filtration. Table 6 summarizes the results of the evaluations made in the above treatment.

TABLE 6

| | Cationic organic coagulant | | | | | | | | | | | |
|---|---|---|---|---|---|---|---|---|---|---|---|---|
| | | | Proportion | | | | | | | | Amount of | |
| | | | to amount | | | | Evaluations of qualities of | | | | solid | |
| | | | of cation | | | | No. 5A two-ply filtrate | | | | component | Esti- |
| | | Amount of | consumed | Amount | Amount | | | | Grade on | | generated | mated |
| Comparative | | coagulant | (by PCD | of MFRAC | of PAC | Coagula- | | | scale de- | | from | volume |
| example/ | | added | ratio) | added | added | tion pH | | | scribed in | | coagulant | of flocs |
| example | Type | (ppm) | (%) | (ppm) | (ppm) | (—) | SFF | MFF | Table 1 | netNTU | (mg/L) | (μL/L) |
| Comparative | — | — | — | — | 0 | 7.5 | 2.45 | 28.47 | 0 | 0.64 | 0 | 0 |
| example16 | | | | | | | | | | | | |
| Comparative | — | — | — | — | 20 | 7.2 | 1.72 | 2.24 | 1 | 0.15 | 3.1 | 160 |
| example17 | | | | | | | | | | | | |
| Comparative | — | — | — | — | 40 | 7.0 | 1.27 | 1.31 | 1~2 | 1.10 | 6.2 | 320 |
| example18 | | | | | | | | | | | | |
| Comparative | — | — | — | — | 60 | 6.8 | 1.14 | 1.126 | 2~3 | 0.04 | 9.4 | 480 |
| example19 | | | | | | | | | | | | |
| Comparative | — | — | — | — | 120 | 6.6 | 1.031 | 1.080 | 4~5 | 0.02 | 18.7 | 960 |
| example20 | | | | | | | | | | | | |
| Example17 | — | — | — | 40 | — | 7.5 | 1.009 | 1.055 | 5 | 0.04 | 3.7 | 280 |
| Comparative | P702 | 0.7 | 59 | 0 | — | 7.5 | 1.50 | 2.48 | 1 | 0.43 | 0.6 | 0.6 |
| example21 | | | | | | | | | | | | |
| Example18 | P702 | 0.7 | 59 | 10 | — | 7.5 | 1.005 | 1.057 | 5 | 0.02 | 1.6 | 71 |
| Example19 | P702 | 0.7 | 59 | 20 | — | 7.5 | 0.983 | 1.029 | 5~S | 0.01 | 2.5 | 141 |
| Example20 | P702 | 0.5 | 42 | 10 | — | 7.5 | 1.020 | 1.065 | 5 | 0.03 | 1.4 | 70 |

The results described in Table 6 confirm the following facts.

The SFFs/MFFs of the filtrates produced by coagulating the industrial water samples I, II, and III and subsequently performing the No. 5A two-ply filtration were 2.56/10.89, 1.45/2.06, and 2.45/28.47, respectively. That is, the MFF of the filtrate produced using the industrial water III was particularly high. This confirms that, among the three industrial water samples, the industrial water III was most contaminated with microparticles.

Furthermore, among the three industrial water samples, the industrial water III most consumed P702.

The relationship between the amount of PAC added to the industrial water and the evaluation grade described in Table 1 given to the filtrate was the same as in the cases where the industrial water samples I and II were used as described in Test Example 3. The coagulation effects of PAC were large compared with the cases where the industrial water samples I and II were used.

However, in Comparative example 17, where 20 mg/L of PAC, at which the aggregate can be directly filtered, was added to the industrial water, an evaluation scale of 1 in Table 1 was given. In Comparative example 18, where the amount of PAC added was doubled, that is, increased to 40 mg/L, the indices were improved but the evaluation grade given to the filtrate was still 1. In the case where PAC was used, it was necessary to increase the amount of PAC to 120 mg/L for achieving an evaluation grade of 4 or higher (Comparative example 20).

In contrast, in Example 17, where 40 mg/L of MFRAC was added to the industrial water, an evaluation grade of 5 described in Table 1 was given. However, the amount of solid substances generated by the coagulant and the volume of flocs estimated from the amount of solid substances were 3.7 mg/L and 280 μL/L, respectively, which were larger than the amount (3.1 mg/L) of solid substances generated in the case where 20 mg/L of PAC, at which direct filtration can be performed, was added to the industrial water and the volume (160 μL/L) of flocs estimated from the amount of solid substances, respectively. Accordingly, it is necessary to use the cationic coagulant (P702) in combination with MFRAC for direct filtration of the aggregate.

In the case where 0.7 mg/L of P702, which corresponds to 59% of the amount (1.19 mg/L) of cation consumed, which is determined by a streaming potential method, was used in combination, as in Example 18, an evaluation grade of 5 was given when 10 mg/L of MFRAC was added to the industrial water. The amount of solid substances generated by the coagulant and the volume of flocs estimated from the amount of solid substances were 1.6 mg/L and 71 μL/L, respectively, which are equal to about ½ of the amount (3.1 mg/L) of solid substances generated in the case where 20 mg/L of PAC was added to the industrial water and the volume (160 μL/L) of flocs estimated from the amount of solid substances, respectively, and are small enough to directly filter the coagulated water.

In Example 19, where 20 mg/L of MFRAC was used in combination, the amount of solid substances generated by the coagulant and the volume of flocs estimated from the amount of solid substances were 2.5 mg/L and 141 μL/L, respectively, which are small enough to directly filter the coagulated water.

In Comparative example 21, where 0.7 mg/L of P702, which corresponds to 59% of the amount of cation consumed, was added to the industrial water and MFRAC was not used, an evaluation grade of 1 described in Table 1 was given.

In Example 20, where 0.5 mg/L of P702, which corresponds to 42% of the amount of cation consumed, and 10 mg/L of MFRAC were added to the industrial water, the advantageous effects comparable to those achieved when 0.7 mg/L of P702 was added were achieved and an evaluation grade of 5 was given.

The above-described results confirm that, on the basis also of the results of the treatment of industrial water samples I and II, it is suitable to add P702 and MFRAC to the industrial water III such that the amount of the main agent, MFRAC, is 10 to 20 mg/L and the amount of P702 is 30% to 70% of the amount of cation consumed.

Although the present invention has been described in detail with reference to particular embodiments, it is apparent to a person skilled in the art that various modifications can be made therein without departing from the spirit and scope of the present invention.

The present application is based on Japanese Patent Application No. 2016-016044 filed on Jan. 29, 2016, which is incorporated herein by reference in its entirety.

1. A method for clarifying industrial water, the method comprising:
adding a melamine-formaldehyde resin acid colloidal solution to industrial water whereby coagulating the industrial water; and
subsequently filtering the coagulated water.

2. The method for clarifying industrial water according to claim 1, the method further comprising adding a cationic organic coagulant to the industrial water prior to the addition of the melamine-formaldehyde resin acid colloidal solution.

3. The method for clarifying industrial water according to claim 2, wherein the amount of the cationic organic coagulant added is 70% or less of the amount of cation included in the cationic organic coagulant, the cation being consumed by the industrial water, the amount of cation being determined by a streaming potential method.

4. The method for clarifying industrial water according to claim 2, wherein the cationic organic coagulant is polydiallyldimethylammonium chloride.

5. The method for clarifying industrial water according to claim 1, wherein the pH of the industrial water is adjusted to be 7 or more in the coagulation treatment by aerating the industrial water or adding an alkali to the industrial water.

6. The method for clarifying industrial water according to claim 1, wherein the coagulated water is directly filtered with a pressure or gravity filtration device without being subjected to solid-liquid separation using a sedimentation separation device or a floatation separation device prior to the filtration treatment.

7. The method for clarifying industrial water according to claim 1, wherein the coagulated water is directly filtered with a microfiltration membrane module or an ultrafiltration membrane module without being subjected to solid-liquid separation using a sedimentation separation device or a floatation separation device prior to the filtration treatment.

8. The method for clarifying industrial water according to claim 1, wherein filtrate produced by the filtration treatment is further treated through a reverse osmosis membrane.

9. An apparatus for clarifying industrial water, the apparatus comprising a coagulation unit that adds a melamine-formaldehyde resin acid colloidal solution to industrial water in order to coagulate the industrial water, and a filtration unit through which coagulated water produced in the coagulation unit is filtered.

10. The apparatus for clarifying industrial water according to claim 9, wherein the coagulation unit adds a cationic organic coagulant to the industrial water prior to the addition of the melamine-formaldehyde resin acid colloidal solution.

11. The apparatus for clarifying industrial water according to claim 10, wherein the amount of the cationic organic coagulant added in the coagulation unit is 70% or less of the amount of cation included in the cationic organic coagulant, the cation being consumed by the industrial water, the amount of cation being determined by a streaming potential method.

12. The apparatus for clarifying industrial water according to claim 10, wherein the cationic organic coagulant is polydiallyldimethylammonium chloride.

13. The apparatus for clarifying industrial water according to claim 9, the apparatus further comprising a pH-control unit that adjusts the pH of the industrial water to be 7 or more in the coagulation unit by aerating the industrial water or adding an alkali to the industrial water.

14. The apparatus for clarifying industrial water according to claim 9, wherein the filtration unit is a pressure or gravity filtration device, and wherein the coagulated water is directly introduced to the filtration unit without being subjected to solid-liquid separation using a sedimentation separation device or a floatation separation device prior to the filtration unit.

15. The apparatus for clarifying industrial water according to claim 9, wherein the filtration unit is a microfiltration membrane module or an ultrafiltration membrane module, and wherein the coagulated water is directly introduced to the filtration unit without being subjected to solid-liquid separation using a sedimentation separation device or a floatation separation device prior to the filtration unit.

16. The apparatus for clarifying industrial water according to claim 9, the apparatus further comprising a reverse osmosis membrane module in which filtrate produced in the filtration unit is further treated through a reverse osmosis membrane
